(19) United States
(12) Patent Application Publication
(10) Pub. No.: US 2018/0254797 A1
(43) Pub. Date: Sep. 6, 2018

(54) SYSTEM AND METHOD FOR DETECTION OF CELL-SPECIFIC REFERENCE SIGNALS

(71) Applicant: QUALCOMM Incorporated, San Diego, CA (US)

(72) Inventors: Pooyan AMINI, San Diego, CA (US); Amir FARAJIDANA, Sunnyvale, CA (US); Sibasish DAS, San Diego, CA (US); Wenshu ZHANG, San Diego, CA (US); Supratik BHATTACHARJEE, San Diego, CA (US); Tao LUO, San Diego, CA (US)

(21) Appl. No.: 15/884,317

(22) Filed: Jan. 30, 2018

Related U.S. Application Data
(60) Provisional application No. 62/467,799, filed on Mar. 6, 2017.
(60) Provisional application No. 62/468,318, filed on Mar. 7, 2017.

(51) Int. Cl. H04B 1/7107; H04W 72/04; H04W 36/00; H04L 1/16

(52) U.S. Cl. CPC H04B 1/7107; H04W 72/0446; H04L 1/1607; H04W 36/0066; H04W 72/042

(57) ABSTRACT

An apparatus may receive a downlink subframe from a serving base station. The downlink subframe may include interference associated with a second subframe transmitted by an intra-frequency neighboring cell (IFNC). The apparatus may detect whether there are interfering cell-specific reference signals (CRS) in one or more symbols of the second subframe. The apparatus may determine, based on whether interfering CRS are detected in the one or more symbols of the second subframe, a subframe type of the second subframe. The apparatus may cancel detected interfering CRS from the received downlink subframe based on the determined subframe type of the second subframe.

### CROSS-REFERENCE TO RELATED APPLICATION(S)

This application claims the benefit of U.S. Provisional Application Ser. No. 62/467,799, entitled “SYSTEM AND METHOD FOR DETECTION OF CELL-SPECIFIC REFERENCE SIGNALS” and filed on Mar. 6, 2017, and the benefit of U.S. Provisional Application Ser. No. 62/468,318, entitled “SYSTEM AND METHOD FOR DETECTION OF CELL-SPECIFIC REFERENCE SIGNALS” and filed on Mar. 7, 2017, the disclosures of which are expressly incorporated by reference herein in their entireties.

### BACKGROUND

### Technical Field

The present disclosure relates generally to communication systems, and more particularly, to an apparatus that may detect cell-specific reference signals that may cause interference.

### Introduction

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

A wireless communication network may include one or more base stations that communicate with various user equipment (UE). Communication between a base station and a UE may be both downlink and uplink. Downlink communication generally refers to a communication link in which the base station transmits signals and the UE receives signals. Uplink communication generally refers to a communication link in which the UE transmits signals and the base station receives signals.

A base station may transmit data and/or control information on the downlink to a UE. On the downlink, the UE may experience interference to signals from the base station, e.g., due to transmissions by other base stations. The interference may degrade performance of the UE. Operations to address such interference may improve performance of the UE.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In various wireless communications systems, a base station may transmit cell-specific reference signals (CRS) in each transmission time interval (TTI) that is valid for downlink transmission (e.g., each downlink subframe). In particular, the base station may transmit a CRS from each downlink antenna port. A user equipment (UE) may detect a CRS and may use the CRS for cell search and initial acquisition, downlink channel quality measurements, downlink channel estimation, and so forth.

In some aspects, the UE may operate in a spectrum that at least partially overlaps with a neighboring cell. Such a neighboring cell may be known as an intra-frequency neighboring cell (IFNC) and may cause interference to communication between the UE and the base station. To mitigate the interference, the UE may perform interference cancellation based on the type of subframe transmitted by the IFNC. Accordingly, the UE may benefit from the autonomous detection of type of subframe, for example, based on the CRS of that subframe.

In an aspect of the disclosure, a method, a computer-readable medium, and an apparatus are provided. The apparatus may be a UE. The apparatus may receive a downlink subframe from a serving base station, and the downlink subframe may at least partially overlap with a second subframe that is transmitted by an IFNC. The apparatus may detect whether there are interfering CRS in one or more symbols of the second subframe. The apparatus may determine, based on whether interfering CRS are detected in the one or more symbols of the second subframe, a subframe type of the second subframe. The apparatus may cancel detected interfering CRS from the received downlink subframe based on the determined subframe type of the second subframe.

In one aspect, the detecting whether there are interfering CRS in one or more symbols of the second subframe includes determining whether there are interfering CRS in symbol zero (0) of the second subframe, and the determining the subframe type includes determining that the second subframe is a downlink subframe when interfering CRS are located in the symbol 0 of the second subframe.

In one aspect, the detection of whether there are interfering CRS in one or more symbols of the second subframe includes determining whether there are interfering CRS in symbol four (4) of the second subframe for normal cyclic prefix (CP) or interfering CRS in symbol three (3) of the second subframe for extended CP, and the determining the subframe type includes determining that the second subframe is a multicast-broadcast single-frequency network (MBSFN) subframe when interfering CRS are not located in the symbol 4 of the second subframe for normal CP or interfering CRS are not located in the symbol 3 of the second subframe for extended CP. In one aspect, the detected interfering CRS from the second subframe are canceled from the received subframe based on the determining that the second subframe is an MBSFN subframe.

In one aspect, the detecting whether there are interfering CRS in one or more symbols of the second subframe includes determining whether there is interfering CRS in at least one of symbol four (4), symbol seven (7), or symbol eleven (11) of the second subframe for normal CP or interfering CRS in at least one of symbol three (3), symbol nine (9), or symbol twelve (12) of the second subframe for extended CP, and the determining the subframe type includes determining that the second subframe is a special subframe when interfering CRS are located in the symbol 4 and the symbol 7 and not located in the symbol 11 of the second subframe for normal CP, or interfering CRS are located in the symbol 4 and not located in the symbol 7 and the symbol 11 of the second subframe for normal CP, or interfering CRS are located in the symbol 3 and the symbol 9 and not located in the symbol 12 of the second subframe for extended CP, or interfering CRS are located in the symbol 3 and not located in the symbol 9 and the symbol 12 of the second subframe for extended CP. In an aspect, the detected interfering CRS from the second subframe are canceled from the received subframe based on the determining that the second subframe is a special subframe.

In one aspect, the canceling the detecting interfering CRS from the received downlink subframe based on the determined subframe type of the second subframe includes canceling interfering CRS in the symbol 4 when interfering CRS are located in the at least one of the symbol 7 or the symbol 11 of the second subframe for normal CP or canceling interfering CRS in the symbol 3 when the interfering CRS are located in the at least one of the symbol 9 or the symbol 11 of the second subframe for extended CP.

In an aspect, the detecting whether there are interfering CRS in one or more symbols of the second subframe includes measuring a signal-to-noise ratio (SNR) associated with at least a first symbol of the one or more symbols, and comparing the measured SNR associated with the first symbol to a threshold. In an aspect, the measured SNR includes a combination of at least a first SNR for CRS on a first port and a second SNR for CRS on a second port.

In an aspect, the apparatus may further perform, on the received downlink subframe, data cancellation associated with the second subframe based on the location of detected interfering CRS in the second subframe. In an aspect, the apparatus may receive information indicating a subframe configuration associated with a second IFNC, and the apparatus may cancel, from the received downlink subframe, interfering CRS associated with the second IFNC based on the received information indicating the subframe configuration associated with the second IFNC.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIGS. 2A, 2B, 2C, and 2D are diagrams illustrating examples of a DL subframe, DL channels within the DL subframe, an UL subframe, and UL channels within the UL subframe, respectively, for a 5G/NR frame structure.

FIG. 3 is a diagram illustrating an example of a base station and user equipment (UE) in an access network.

FIGS. 4A, 4B, 4C, and 4D are diagrams of downlink subframes.

FIGS. 5A and 5B are diagrams of special subframes.

FIG. 6 is a call flow diagram of a wireless communications system.

FIGS. 7A, 7B, and 7C are flowcharts of a methods of wireless communication.

FIG. 8 is a conceptual data flow diagram illustrating the data flow between different means/components in an exemplary apparatus.

FIG. 9 is a diagram illustrating an example of a hardware implementation for an apparatus employing a processing system.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

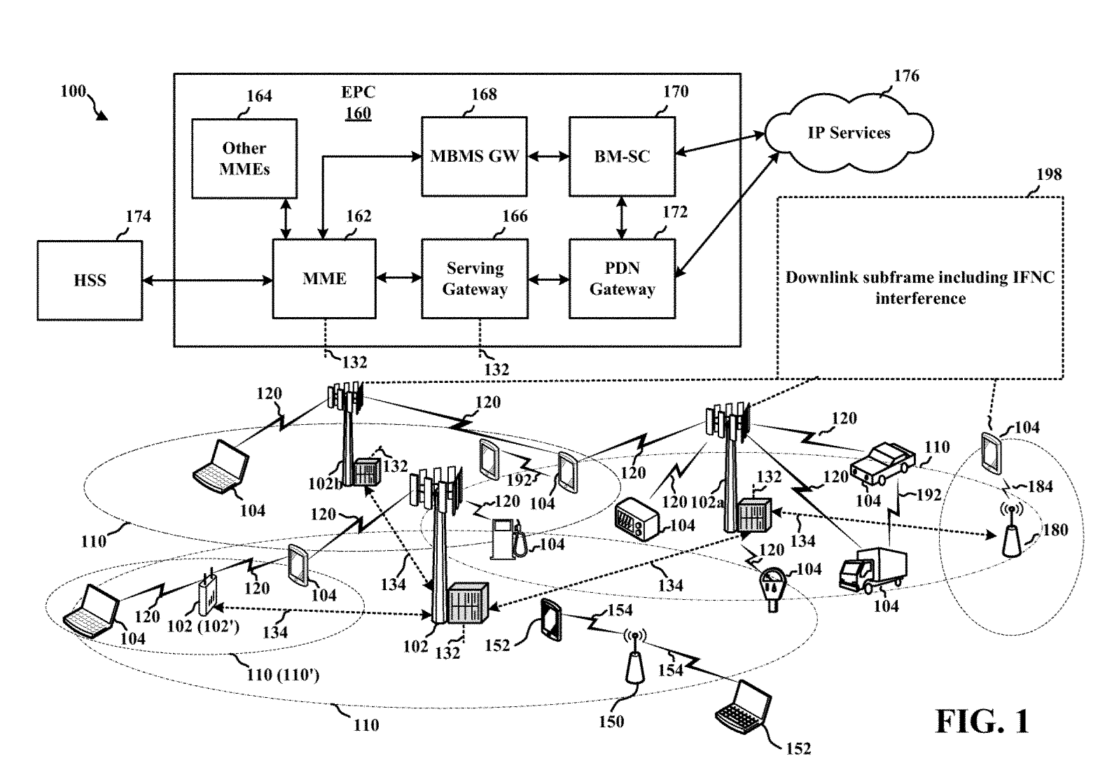

FIG. 1 is a diagram illustrating an example of a wireless communications system and an access network 100. The wireless communications system (also referred to as a wireless wide area network (WWAN)) includes base stations 102, UEs 104, and an Evolved Packet Core (EPC) 160. The base stations 102 may include macro cells (high power cellular base station) and/or small cells (low power cellular base station). The macro cells include base stations. The small cells include femtocells, picocells, and microcells.

The base stations 102 (collectively referred to as Evolved Universal Mobile Telecommunications System (UMTS) Terrestrial Radio Access Network (E-UTRAN)) interface with the EPC 160 through backhaul links 132 (e.g., S1 interface). In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160) with each other over backhaul links 134 (e.g., X2 interface). The backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macro cells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100 MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or less carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 192. The D2D communication link 192 may use the DL/UL WWAN spectrum. The D2D communication link 192 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, LTE, or NR.

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage to and/or increase capacity of the access network.

The gNodeB (gNB) 180 may operate in millimeter wave (mmW) frequencies and/or near mmW frequencies in communication with the UE 104. When the gNB 180 operates in mmW or near mmW frequencies, the gNB 180 may be referred to as an mmW base station. Extremely high frequency (EHF) is part of the RF in the electromagnetic spectrum. EHF has a range of 30 GHz to 300 GHz and a wavelength between 1 millimeter and 10 millimeters. Radio waves in the band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band has extremely high path loss and a short range. The mmW base station 180 may utilize beamforming 184 with the UE 104 to compensate for the extremely high path loss and short range.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The base station may also be referred to as a gNB, Node B, evolved Node B (eNB), an access point, a base transceiver station, a radio base station, a radio transceiver, a transceiver function, a basic service set (BSS), an extended service set (ESS), or some other suitable terminology. The base station 102 provides an access point to the EPC 160 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Referring again to FIG. 1, in certain aspects, a UE 104 may operate on a cell provided by a serving base station 102a. The UE 104 may be proximate to a neighboring cell provided by a neighboring base station 102b. The neighboring cell 102b may operate in a frequency spectrum that at least partially overlaps with the frequency spectrum in which the serving base station 102a operates. For example, the serving base station 102a and the neighboring base station 102b may both operate according to a same radio access technology (RAT). The neighboring base station 102b may provide an intra-frequency neighboring cell (IFNC) with respect to the cell provided by the serving base station 102a.

Because the neighboring base station 102b provides an IFNC, the neighboring base station 102b may introduce interference to communication between the UE 104 and the serving base station 102a. The UE 104 may be configured to perform interference cancellation in downlink subframes, e.g., so that the UE 104 may successfully demodulate or decode a signal in a subframe from the serving base station 102a. In order to perform interference cancellation, the UE 104 may detect a type of subframe from the IFNC that interferes with a downlink subframe from the serving base station 102a. In aspects, the UE 104 may detect the type of subframe from the IFNC based on cell-specific reference signals (CRS) carried in that subframe from the IFNC.

In various aspects, the UE 104 may receive a downlink subframe 198 from the serving base station 102a. The downlink subframe 198 may at least partially overlap with a second subframe of the IFNC that is transmitted by the neighboring base station 102b and the downlink subframe 198 may include interference associated with the second subframe. The UE 104 may detect whether there are interfering reference signals in one or more symbols of the second subframe. The UE 104 may determine, based on whether interfering reference signals are detected in the one or more symbols of the second subframe, a subframe type of the second subframe. Based on the determined subframe type of the second subframe, the UE 104 may cancel detected interfering reference signals from the received downlink subframe 198.

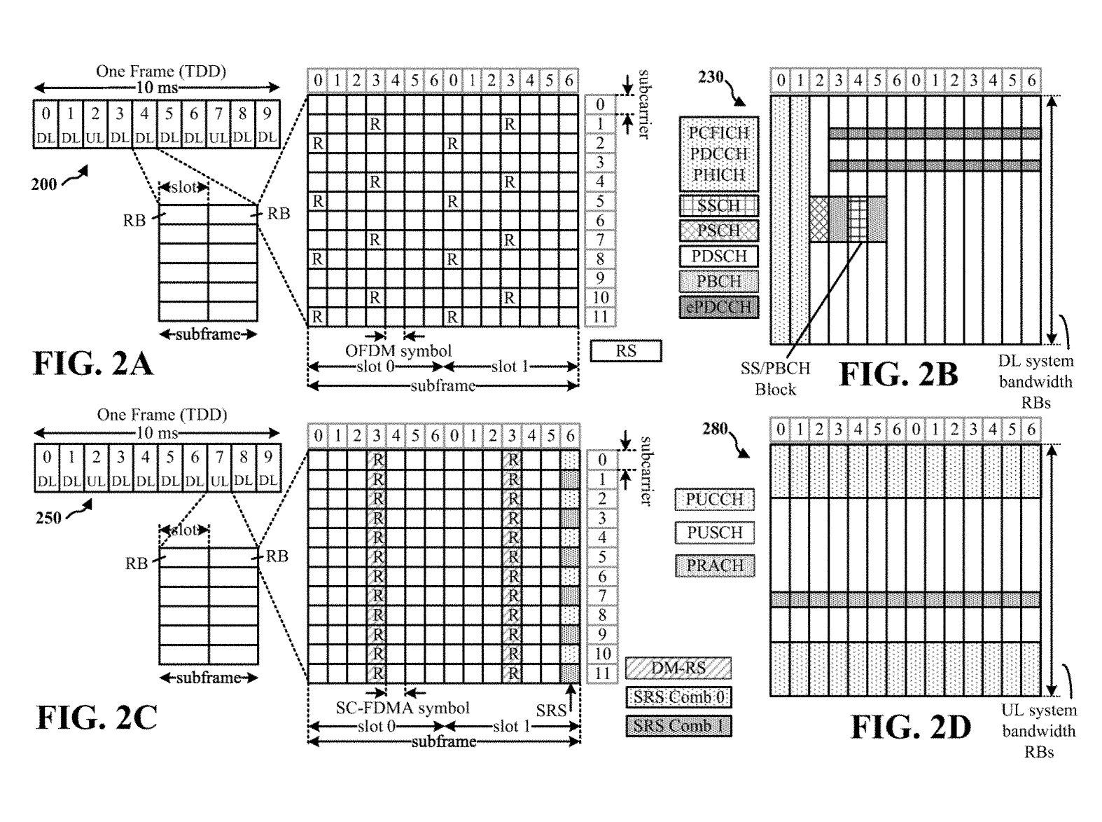

FIG. 2A is a diagram 200 illustrating an example of a DL subframe within a 5G/NR frame structure. FIG. 2B is a diagram 230 illustrating an example of channels within a DL subframe. FIG. 2C is a diagram 250 illustrating an example of an UL subframe within a 5G/NR frame structure. FIG. 2D is a diagram 280 illustrating an example of channels within an UL subframe. The 5G/NR frame structure may be FDD in which for a particular set of subcarriers (carrier system bandwidth), subframes within the set of subcarriers are dedicated for either DL or UL, or may be TDD in which for a particular set of subcarriers (carrier system bandwidth), subframes within the set of subcarriers are dedicated for both DL and UL. In the examples provided by FIGS. 2A, 2C, the 5G/NR frame structure is assumed to be TDD, with subframe 4 a DL subframe and subframe 7 an UL subframe. While subframe 4 is illustrated as providing just DL and subframe 7 is illustrated as providing just UL, any particular subframe may be split into different subsets that provide both UL and DL. Note that the description infra applies also to a 5G/NR frame structure that is FDD.

Other wireless communication technologies may have a different frame structure and/or different channels. A frame (10 ms) may be divided into 10 equally sized subframes (1 ms). Each subframe may include one or more time slots. Each slot may include 7 or 14 symbols, depending on the slot configuration. For slot configuration 0, each slot may include 14 symbols, and for slot configuration 1, each slot may include 7 symbols. The number of slots within a subframe is based on the slot configuration and the numerology. For slot configuration 0, different numerologies 0 to 5 allow for 1, 2, 4, 8, 16, and 32 slots, respectively, per subframe. For slot configuration 1, different numerologies 0 to 2 allow for 2, 4, and 8 slots, respectively, per subframe. The subcarrier spacing and symbol length/duration are a function of the numerology. The subcarrier spacing may be equal to 2^{μ}*15 kKz, where μ is the numerology 0-5. The symbol length/duration is inversely related to the subcarrier spacing. FIGS. 2A, 2C provide an example of slot configuration 1 with 7 symbols per slot and numerology 0 with 2 slots per subframe. The subcarrier spacing is 15 kHz and symbol duration is approximately 66.7 μs.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE (indicated as R). The RS may include demodulation RS (DM-RS) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various channels within a DL subframe of a frame. The physical control format indicator channel (PCFICH) is within symbol 0 of slot 0, and carries a control format indicator (CFI) that indicates whether the physical downlink control channel (PDCCH) occupies 1, 2, or 3 symbols (FIG. 2B illustrates a PDCCH that occupies 3 symbols). The PDCCH carries downlink control information (DCI) within one or more control channel elements (CCEs), each CCE including nine RE groups (REGs), each REG including four consecutive REs in an OFDM symbol. A UE may be configured with a UE-specific enhanced PDCCH (ePDCCH) that also carries DCI. The ePDCCH may have 2, 4, or 8 RB pairs (FIG. 2B shows two RB pairs, each subset including one RB pair). The physical hybrid automatic repeat request (ARQ) (HARQ) indicator channel (PHICH) is also within symbol 0 of slot 0 and carries the HARQ indicator (HI) that indicates HARQ acknowledgement (ACK)/negative ACK (NACK) feedback based on the physical uplink shared channel (PUSCH). The primary synchronization channel (PSCH) may be within symbol 6 of slot 0 within subframes 0 and 5 of a frame. The PSCH carries a primary synchronization signal (PSS) that is used by a UE 104 to determine subframe/symbol timing and a physical layer identity. The secondary synchronization channel (SSCH) may be within symbol 5 of slot 0 within subframes 0 and 5 of a frame. The SSCH carries a secondary synchronization signal (SSS) that is used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DL-RS. The physical broadcast channel (PBCH), which carries a master information block (MIB), may be logically grouped with the PSCH and SSCH to form a synchronization signal (SS)/PBCH block. The MIB provides a number of RBs in the DL system bandwidth, a PHICH configuration, and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry demodulation reference signals (DM-RS) for channel estimation at the base station. The UE may additionally transmit sounding reference signals (SRS) in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various channels within an UL subframe of a frame. A physical random access channel (PRACH) may be within one or more subframes within a frame based on the PRACH configuration. The PRACH may include six consecutive RB pairs within a subframe. The PRACH allows the UE to perform initial system access and achieve UL synchronization. A physical uplink control channel (PUCCH) may be located on edges of the UL system bandwidth. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (B SR), a power headroom report (PHR), and/or UCI.

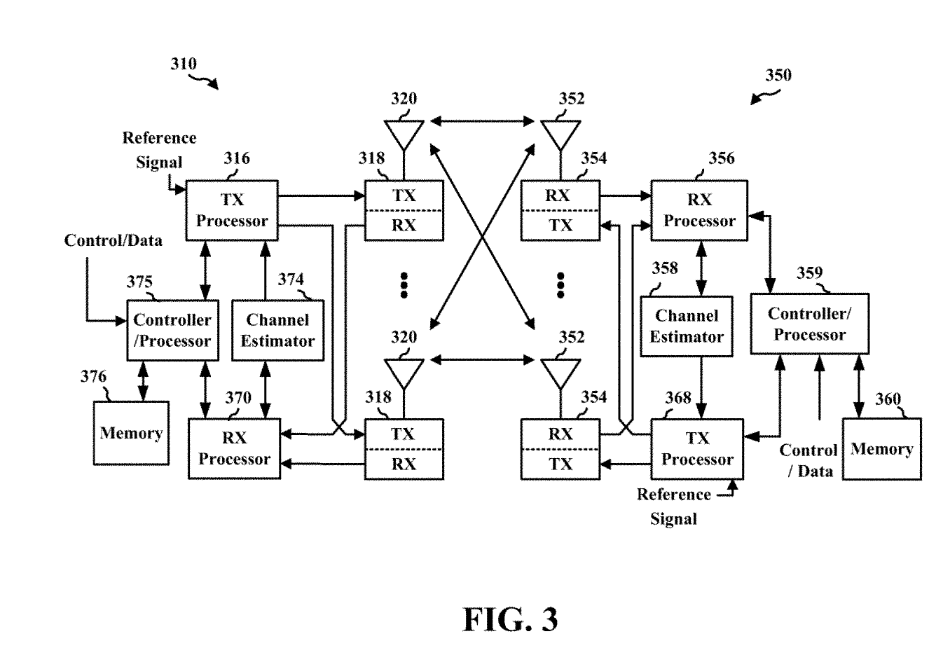

FIG. 3 is a block diagram of a base station 310 in communication with a UE 350 in an access network. In the DL, IP packets from the EPC 160 may be provided to a controller/processor 375. The controller/processor 375 implements layer 3 and layer 2 functionality. Layer 3 includes a radio resource control (RRC) layer, and layer 2 includes a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318TX. Each transmitter 318TX may modulate an RF carrier with a respective spatial stream for transmission.

At the UE 350, each receiver 354RX receives a signal through its respective antenna 352. Each receiver 354RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the base station 310 in a manner similar to that described in connection with the receiver function at the UE 350. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK and/or NACK protocol to support HARQ operations.

As described, supra, a UE may perform interference cancellation based on a type of subframe from an IFNC that at least partially overlaps with a subframe received from a serving base station. However, the UE may be uninformed of the type of IFNC subframe that at least partially overlaps with a downlink subframe intended for the UE. In order to successfully cancel interference from a downlink subframe intended for the UE, the UE may first determine the configuration of the IFNC subframe. In particular, the UE may detect references signals in the IFNC subframe in order to determine the configuration of the IFNC subframe so that interference introduced by the IFNC subframe may be cancelled.

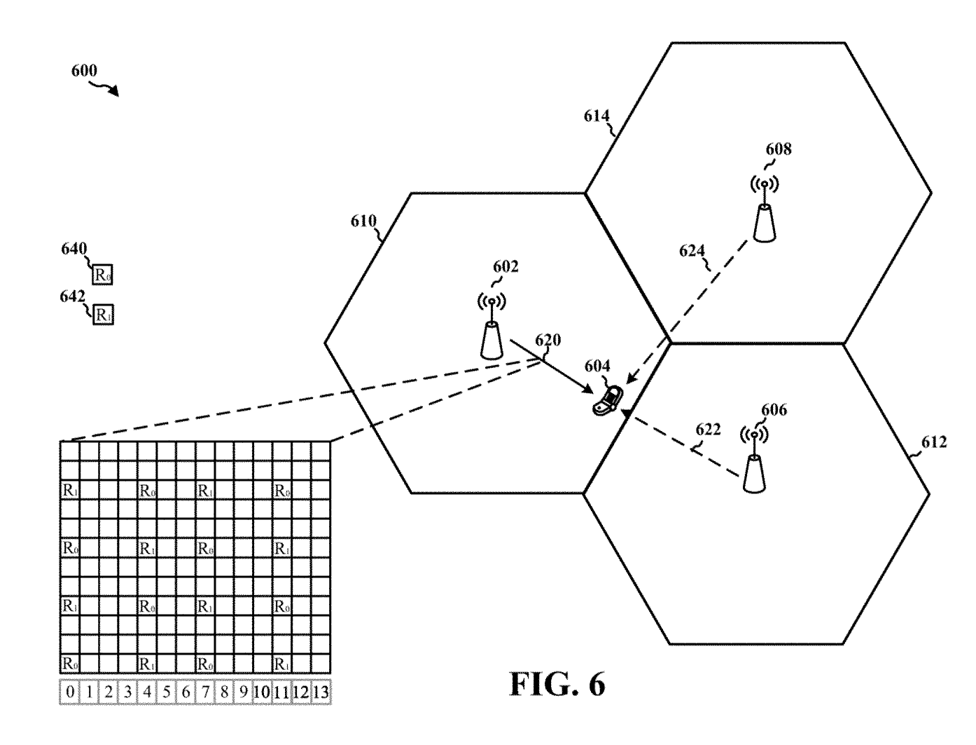

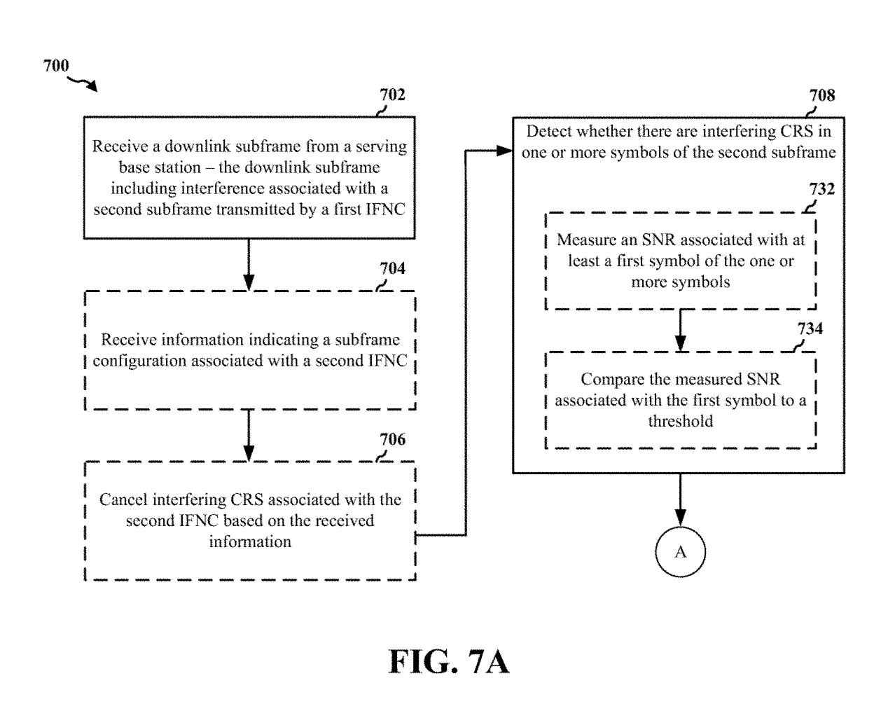

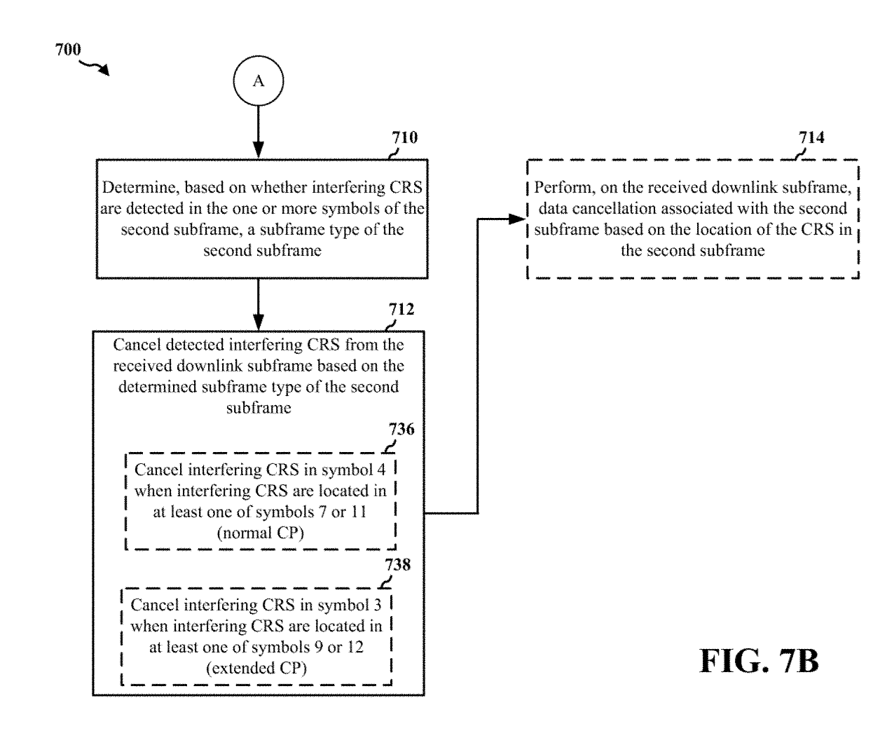

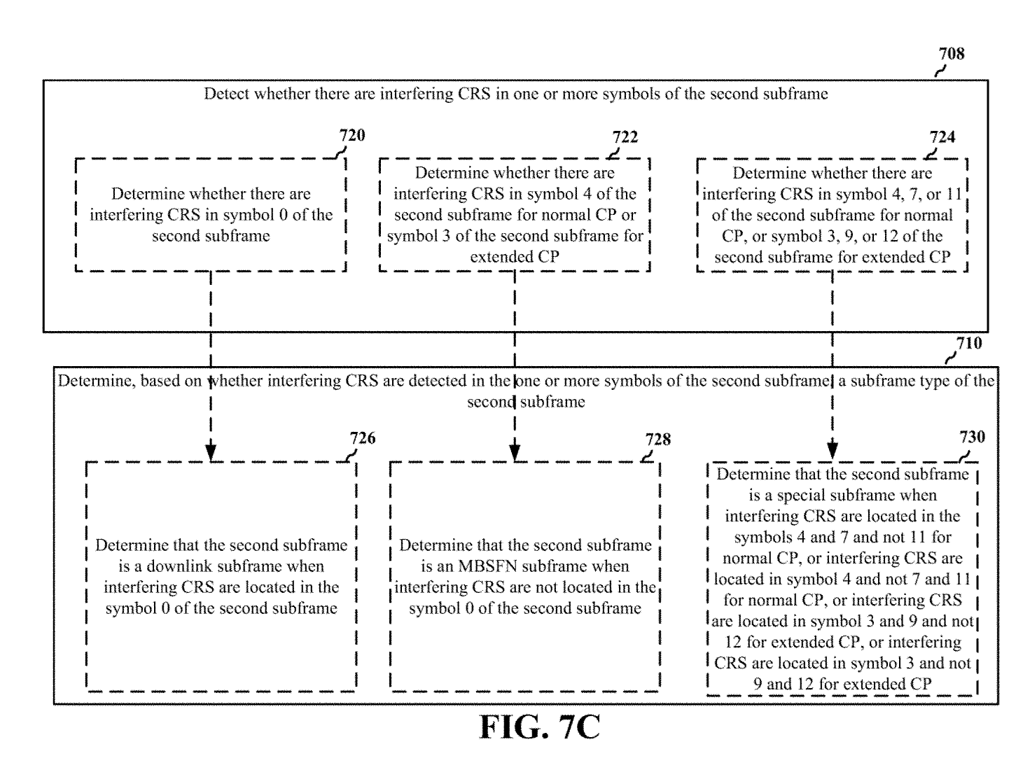

Once the UE is able to determine a type of IFNC subframe (e.g., based on whether interfering reference signals are detected in one or more symbols of the IFNC subframe), the UE may perform various operations in order to reduce interference to the signal in the subframe intended for the UE. For example, the UE may perform data interference cancellation, channel estimation, noise estimation, channel state feedback processing, etc. Such an approach implemented by a UE may be illustrated in FIG. 6, and methods for practicing such an approach may be illustrated in FIGS. 7A and 7B.

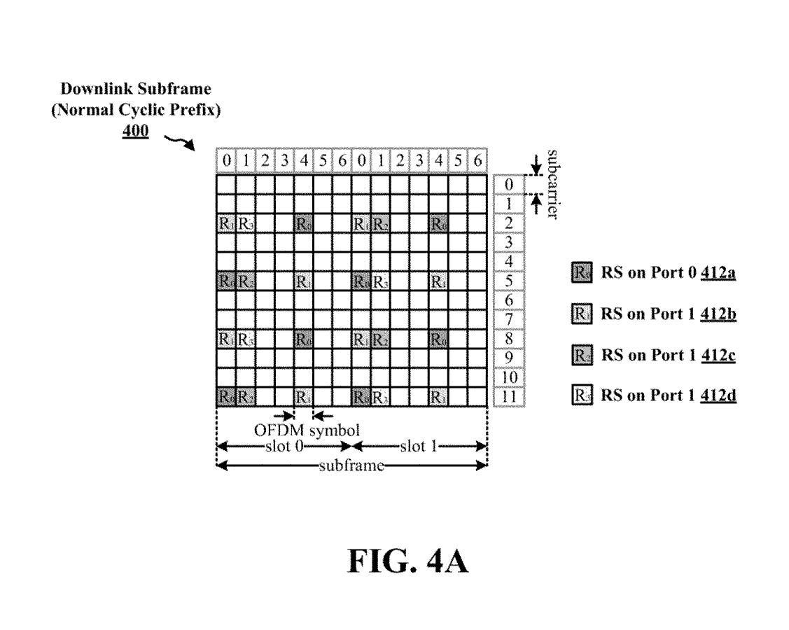

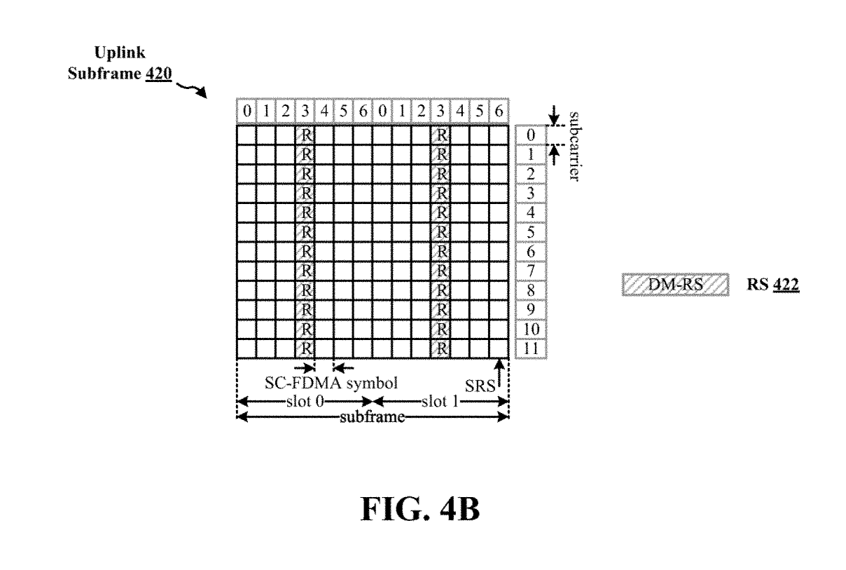

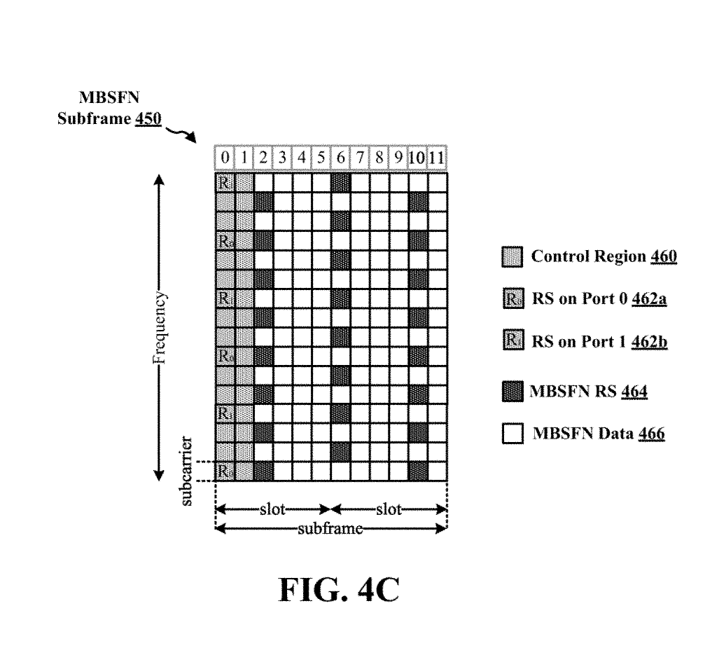

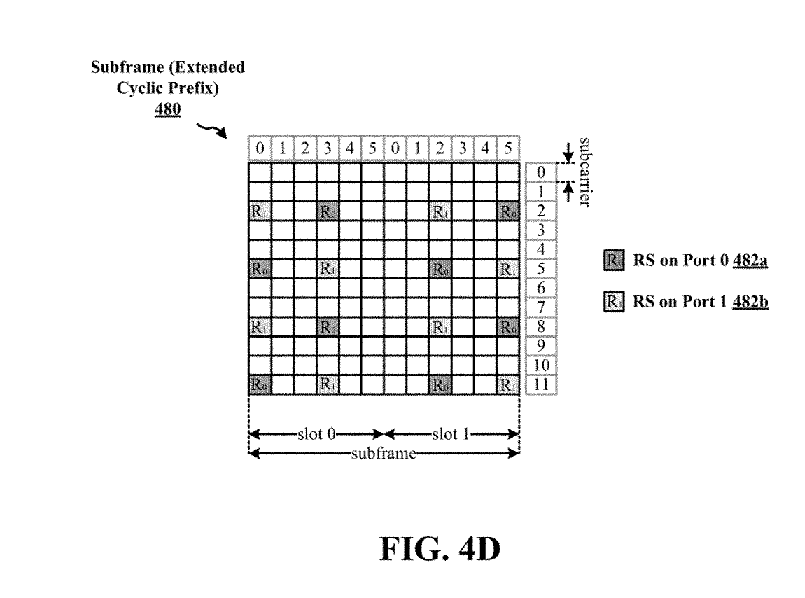

One example of IFNC subframes that may cause interference to a subframe intended for the UE may include LTE subframes. For example, the UE may be unaware of configurations of TDD and MBSFN subframes until the UE successfully decodes a SIB (e.g., SIB1 for TDD configuration, SIB2 for MBSFN configuration, etc.). However, the UE may not successfully decode a SIB of an IFNC, and so the UE may detect a type of subframe based on CRS detection of the IFNC subframe. FIGS. 4A, 4B, 4C, and 4D may illustrate aspects of some IFNC subframes.

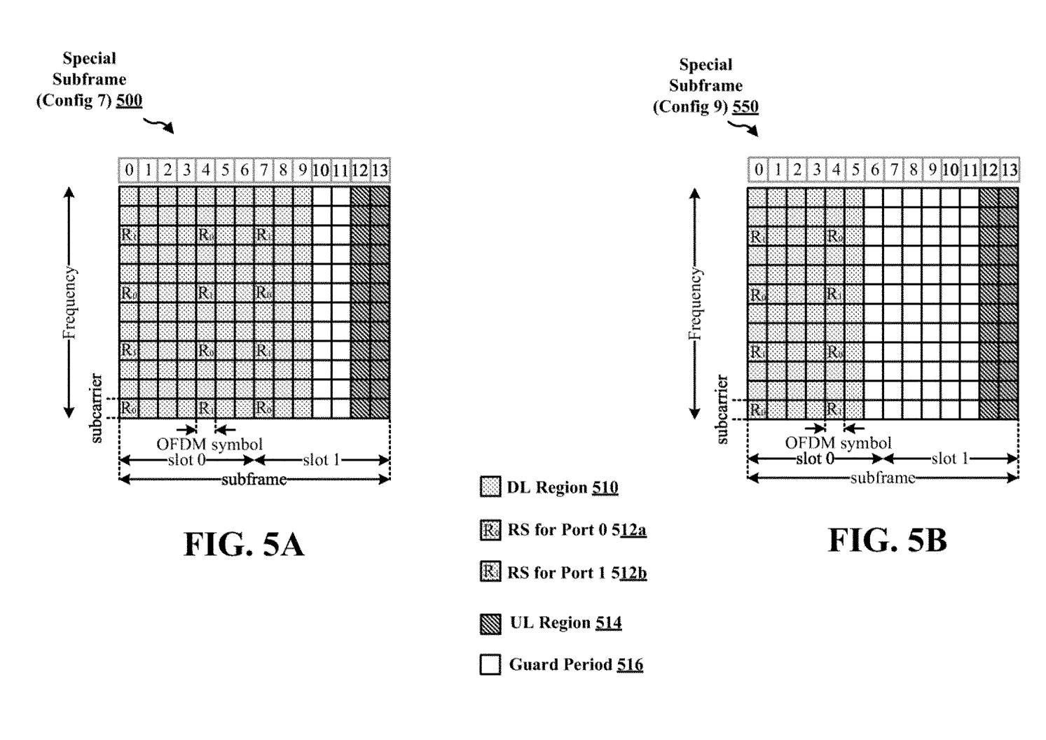

In another example, IFNC subframes that cause interference to a subframe intended for the UE may include special subframes. Special subframes may include both an uplink portion and a downlink portion, as well as a gap (e.g., to facilitate transmission and reception switching). The downlink portion of a special subframe may include reference signals (e.g., CRS) that the UE may detect in order to perform interference cancellation. FIGS. 5A and 5B may illustrate aspects of IFNC subframes that may be special subframes.

Another example of IFNC subframes that may cause interference to a subframe intended for the UE may include subframes in an unlicensed or shared frequency spectrum, such as LTE-Unlicensed (LTE-U), License Assisted Access (LAA), and/or MulteFire subframes. In aspects, CRS may be absent from some subframes in an unlicensed or shared frequency spectrum. In another example, an IFNC may communicate as a lean carrier, in which some reference signals (including some CRS) are absent in order to reduce signaling overhead.

With reference to FIGS. 4A, 4B, 4C, 4D, 5A, and 5B, a RAT communicates with a transmission time interval (TTI) configuration having a frame structure. In one aspect, the frame structure may have a duration of 10 ms and may be divided into 10 subframes (e.g., each having a duration of 1 ms). Each frame may include two slots of duration 0.5 ms.

FIG. 4A is diagram of a downlink subframe 400. The downlink subframe 400 may have a normal cyclic prefix (CP) and, accordingly, may include fourteen total symbols with seven symbols per slot. Some REs of the downlink subframe 400 may include CRS 412. As illustrated the CRS 412 may include, for example, a reference signal on port 0 RS₀ 412aa reference signal on port 1 RS₁ 412b, a reference signal on port 2 RS₂ 412c, and a reference signal on port 3 RS₃ 412d. Accordingly, a UE may detect CRS on ports 0 and 1 on symbol 0, symbol 4, symbol 7, and symbol 11. The UE may detect CRS on ports 2 and 3 on symbol 1 and symbol 8. The number of ports may be increased or decreased, e.g., relative to the number of physical antennas.

FIG. 4B is a diagram of an uplink subframe 420. Some REs of the uplink subframe 420 may carry reference signals. For example, DM-RS 422 may be carried in symbol 3 and symbol 10 (e.g., symbol 3 of slot 2). In some aspects, DM-RS 422 may be carried on all subcarriers of the uplink subframe 420. The DM-RS 422 may be used for channel estimation by a base station. A UE may detect an absence of CRS in the uplink subframe 420, although the uplink subframe 420 may interfere with a downlink subframe received by the UE when the uplink subframe is transmitted in an IFNC relative to the UE.

FIG. 4C is a diagram of an MBSFN subframe 450. In aspects, the MBSFN subframe 450 may be used in time-division duplexing (TDD) and/or frequency division duplexing (FDD) systems. The MBSFN subframe 450 may include a control region 460. The MBSFN subframe 450 may further include an MBSFN region having a plurality of MBSFN RS 464 and MBSFN data 466. In the illustrated aspect, the MBSFN subframe 450 may include 12 OFDM symbols, for example, when extended CP is used. In one aspect, the MBSFN subframe 450 includes 16 subcarriers, e.g., due to a higher frequency density relative to the downlink subframe 400. As illustrated, a reference signal on port 0 RS₀ 462a may be carried on one set of symbols of the control region 460 and a reference signal on port 1 RS₁ 462b on another set of symbols of the control region 460. The reference signals RS₀ 462a and RS₁ 462b may be CRS. Accordingly, a UE may detect CRS on ports 0 and 1 on symbol 0, but may detect an absence of CRS on symbol 4.

FIG. 4D is diagram of a downlink subframe 480, according to another aspect. The downlink subframe 480 may use an extended CP and, accordingly, may include twelve total symbols with six symbols per slot. Some REs of the downlink subframe 480 may include CRS 482. As illustrated the CRS 482 may include, for example, a reference signal on port 0 RS₀ 482a and a reference signal on port 1 RS₁ 482b. For a subframe using extended CP, a UE may detect CRS on ports 0 and 1 on symbol 0, symbol 3, symbol 9, and symbol 12.

FIGS. 5A and 5B illustrate exemplary special subframes 500, 550. The special subframes 500, 550 may be used for switching between downlink and uplink and, therefore, may include a guard period (GP) 516 (e.g., switching between a transmitter and receiver may occur during a GP 516). The special subframes 500, 550 illustrate two possible configurations of special subframes that may be used by a RAT. For example, special subframe configurations may be defined in one or more 3GPP technical standards for LTE, as given in Table 1 for normal CP in the downlink region and Table 2 for extended CP in the downlink region.

TABLE 1

| | # of symbols/ | # of symbols/ | # of symbols/ |
|---|---|---|---|
| Configuration | subframe DL | subframe GP | subframe UL |
| 0 | 3 | 10 | 1 |
| 1 | 9 | 4 | 1 |
| 2 | 10 | 3 | 1 |
| 3 | 11 | 2 | 1 |
| 4 | 12 | 1 | 1 |
| 5 | 3 | 9 | 2 |
| 6 | 9 | 3 | 2 |
| 7 | 10 | 2 | 2 |
| 8 | 11 | 1 | 2 |
| 9 | 6 | 6 | 2 |

TABLE 2

| | # of slots/ | # of slots/ | # of slots/ |
|---|---|---|---|
| Configuration | subframe DL | subframe GP | subframe UL |
| 0 | 3 | 8 | 1 |
| 1 | 8 | 3 | 1 |
| 2 | 9 | 2 | 1 |
| 3 | 10 | 1 | 1 |
| 4 | 3 | 7 | 2 |
| 5 | 8 | 2 | 2 |
| 6 | 9 | 1 | 2 |
| 7 | 5 | 5 | 2 |

The first special subframe 500 may illustrate a special subframe configuration 7 for normal CP, and the second special subframe 550 may illustrate a special subframe configuration 9 for normal CP. For extended CP, references signals (e.g., RS 482) may occur in a downlink region, consistent with subframe 480 of FIG. 4D, but may be absent from symbols corresponding to the GP and the uplink region.

With reference to FIG. 5A, the first special subframe 500 using normal CP may include 10 symbols allocated for a downlink region 510, 2 symbols allocated for the GP 516, and 2 symbols allocated for the uplink region 514. In configurations, CRS may be carried in only the downlink region 510, and not the GP 516 and uplink region 514. As illustrated, the downlink region 510 may carry a reference signal on port 0 RS₀ 512a and a reference signal on port 1 RS₁ 512b. In various aspects, the downlink region 510 may carry additional signals. With respect to the GP 516 and the uplink region 514, however, CRS may be absent. Accordingly, a UE may detect CRS on ports 0 and 1 on symbol 0, symbol 4, and symbol 7, but may detect an absence of CRS on symbol 11 of the first special subframe 500.

By way of example, a special subframe of configuration 7 using extended CP may include 5 symbols allocated for a downlink region, 5 symbols allocated for a GP, and 2 symbols allocated for an uplink region (for a total of 12 symbols). CRS may be carried in the downlink region, and not carried in the GP and the uplink region. With reference to FIG. 4D, a special subframe of configuration 7 using extended CP may be similar to the subframe 480. However, a special subframe of configuration 7 using extended CP may have a downlink region of 5 symbols. The downlink region of 5 symbols may carry reference signals on port 0 RS₀ 482a on symbols 0 and 3, and may carry reference signals on port 1 RS₁ 482b on symbols 0 and 3. With the special subframe of configuration 7, reference signals may be absent from the remaining symbols (including symbols 9 and 12). Accordingly, a UE may detect CRS on ports 0 and 1 on symbols 0 and 3, but may detect an absence of CRS on symbols 9 and 12 of a special subframe of configuration 7 using extended CP.

Turning to FIG. 5B, the second special subframe 550 may include 6 symbols allocated for the downlink region 510, 6 symbols allocated for the GP 516, and 2 symbols allocated for the uplink region 514. In various aspects, the downlink region 510 may carry a reference signal on port 0 RS₀ 512a and a reference signal on port 1 RS₁ 512b. Like the first special subframe 500, CRS may be absent from the GP 516 and uplink region 514. Accordingly, a UE may detect CRS on ports 0 and 1 on symbol 0 and symbol 4, but may detect an absence of CRS on symbol 7 and symbol 11 of the second special subframe 550.

By way of another example, a special subframe of configuration 3 using extended CP may include 10 symbols allocated for a downlink region, 1 symbol allocated for a GP, and 1 symbol allocated for an uplink region (for a total of 12 symbols). CRS may be carried in the downlink region, and not carried in the GP and the uplink region. With reference to FIG. 4D, a special subframe of configuration 3 using extended CP may be similar to the subframe 480. However, a special subframe of configuration 3 using extended CP may have a downlink region of 10 symbols. The downlink region of 10 symbols may carry reference signals on port 0 RS₀ 482a on symbols 0, 3, and 9, and may carry reference signals on port 1 RS₁ 482b on symbols 0, 3, and 9. With the special subframe of configuration 3, reference signals may be absent from the remaining symbols (including symbol 12). Accordingly, a UE may detect CRS on ports 0 and 1 on symbols 0, 3, and 9, but may detect an absence of CRS on symbol 12 of a special subframe of configuration 3 using extended CP.

Now with reference to FIG. 6, a wireless communications system 600 is illustrated in accordance with various aspects of the present disclosure. The wireless communications system 600 may include a UE 604. The UE 604 may operate on a serving cell 610 provided by a serving base station 602.

The serving base station 602 may transmit a downlink subframe 620 to the UE 604 that includes CRS, including reference signals on port 0 R₀ 640 and on port 1 R₁ 642 (although more or fewer ports are possible, e.g., relative to the number of physical antennas). In some aspects, the reference signals R₀ 640 and R₁ 642 may be wideband (e.g., the same at a downlink system bandwidth). In other aspects, the reference signals R₀ 640 and R₁ 642 may be narrowband in the center (e.g., 1.4 MHz in the center). The UE 604 may use CRS for a plurality of operations, for example, including timing tracking, frequency tracking, channel estimation, mobility management, channel state information feedback, and so forth.

The UE 604 may be proximate to one or more other cells provided by one or more other base stations. The one or more other cells may operate in a frequency spectrum that at least partially overlaps with the frequency spectrum of the serving cell 610. Therefore, the one or more other cells may be IFNCs with respect to the serving cell 610. For example, a first neighboring base station 606 may provide a first IFNC 612, and a second neighboring base station 608 may provide a second 614.

Because the IFNCs 612, 614 operate at least partially in the same frequency spectrum as the serving cell 610, the IFNCs 612, 614 may introduce interference, e.g., to downlink communication between the serving base station 602 and the UE 604. For example, the UE 604 may experience interference of CRS for one or more antenna ports in one or more symbols, and/or the UE 604 may experience interference in other REs carrying data or control information. In some aspects, interference due to CRS transmission from at least one IFNC 612, 614 may cause performance degradation at the UE 604 when receiving data and/or control channels from the serving base station 602. For example, channel estimation may be degraded due to interfering reference signals transmission from at least one IFNC 612, 614.

In order to address interference introduced from at least one IFNC 612, 614, the UE 604 may perform interference cancellation, e.g., for one or more ports on which CRS are transmitted and/or for one or more subcarriers on which data and/or control information is carried. The UE 604 may perform interference cancellation based on a type of subframe from an IFNC 612, 614 that causes interference to a downlink subframe from the serving base station 602 in the serving cell 610. For example, the UE 604 may determine a subframe type from the first IFNC 612 is one of a downlink subframe (e.g., the downlink subframe 400 using normal CP, the downlink subframe 480 using extended CP), an uplink subframe (e.g., the uplink subframe 420, a TDD uplink subframe that carries no CRS), an MBSFN subframe (e.g., the MBSFN subframe 450), a special subframe (e.g., the first special subframe 500, the second special subframe 550, and/or another TDD special subframe), or another type of subframe.

When the UE 604 determines the type of IFNC subframe that interferes with a downlink subframe from the serving base station 602, the UE 604 may perform interference cancellation. In some aspects, the UE 604 may implement an interference cancellation algorithm upon determining the configuration of an IFNC subframe. For example, the UE 604 may subtract an interfering reference signals from the received signal carried in the downlink subframe from the serving base station 602.

As illustrated, the UE 604 may receive, from the serving base station 602, a downlink subframe 620. The downlink subframe 620 may include CRS on one or more ports. For example, the downlink subframe 620 may include CRS on a first port 0 R₀ 640 and may include CRS on a second port 1 R₁ 642. The CRS R₀ 640 may be carried in symbol 0, symbol 4, symbol 7 (e.g., symbol 0 of slot 1), and symbol 11 (e.g., symbol 4 of slot 1). Similarly, CRS R₁ 642 may be carried in symbol 0, symbol 4, symbol 7 (e.g., symbol 0 of slot 1), and symbol 11 (e.g., symbol 4 of slot 1). The CRS R₀ 640 may be carried on different subcarriers than the CRS R₁ 642.

In the illustrated aspect, the downlink subframe 620 may use normal CP. However, aspects of the present disclosure may apply to extended CP. When the downlink subframe 620 uses extended CP, the downlink subframe 620 may include 12 symbols, with each slot having 6 symbols. For extended CP, the reference signals R₀ 640 and R₁ 642 may occur on symbols 0, 3, 9, and 12 (e.g., as illustrated in FIG. 4D, supra).

With the proximity of the IFNCs 612, 614, the UE 604 may experience interference to the downlink subframe 620. For example, the UE 604 may receive the downlink subframe 620 that at least partially overlaps with an IFNC subframe 622 and, therefore, may include interference associated with the IFNC subframe 622 transmitted by the first neighboring base station 606 for the first IFNC 612. In various aspects, the IFNC subframe 622 may be a downlink subframe (e.g., an aspect of the downlink subframe 400), an uplink subframe (e.g., an aspect of the uplink subframe 420), an MBSFN subframe (e.g., an aspect of the MBSFN subframe 450), a special subframe (e.g., an aspect of the first special subframe 500 or the second special subframe 550).

The UE 604 may be configured to detect interference introduced by the IFNC subframe 622 to the downlink subframe 620. In one aspect, the UE 604 may detect whether there are interfering reference signals in one or more symbols of the IFNC subframe 622, which may cause interference to CRS of the downlink subframe 620. The interfering reference signals may degrade channel estimation by the UE 604. According to one aspect, the UE 604 may detect whether at least one symbol of the downlink subframe 620 that includes reference signals R₀ 640 or R₁ 642 includes interference due to CRS of the IFNC subframe 622 from the first IFNC 612. In so doing, the UE 604 may detect the type of the IFNC subframe 622 so that the UE 604 may perform interference cancellation of the interfering reference signals.

In one aspect, the UE 604 may detect whether there are interfering reference signals introduced by the IFNC subframe 622 to the reference signals R₀ 640 and R₁ 642 of the downlink subframe 620 based on a signal-to-noise ratio (SNR). In particular, the UE 604 may measure the SNR in one or more symbols that include the reference signals R₀ 640 and R₁ 642 of the downlink subframe 620. For example, the UE 604 may estimate the signal power and noise variance in either the frequency domain or the time domain in order to measure the SNR. Subsequently, the UE 604 may compare the measured SNR to a first threshold, e.g., in order to determine whether the measured SNR meets or exceeds the first threshold. Based on the comparison, the UE 604 may detect whether there are interfering reference signals. In other words, the UE 604 may determine that reference signals R₀ 640 and R₁ 642 of the downlink subframe 620 include interfering reference signals of the downlink subframe 620 when measured SNR meets or exceeds the first threshold.

In various aspects, the UE 604 may detect whether there are interfering reference signals for each symbol in which the UE 604 expects reference signals R₀ 640 and R₁ 642 of the downlink subframe 620. For example, the UE 604 may measure the SNR of reference signal R₀ 640 in symbol 0. Similarly, the UE 604 may measure the SNR of the reference signal R₁ 642 in symbol 0. The UE 604 may similarly measure the SNR for reference signals R₀ 640 and R₁ 642 in each symbol of the downlink subframe 620 that is configured for CRS, e.g., including symbol 4, symbol 7, and symbol 11.

The UE 604 may detect whether there are interfering reference signals introduced by the IFNC subframe 622 to the reference signals R₀ 640 and R₁ 642 of the downlink subframe 620 by measuring SNR, e.g., when a hypothesized form of a reference signal is unknown. However, the UE 604 may also perform SNR measurement for detection of interfering reference signals when channel and/or noise information associated with the downlink subframe 620 is determined by the UE 604.

In another aspect, the UE 604 may detect whether there are interfering reference signals introduced by the IFNC subframe 622 to the reference signals R₀ 640 and R₁ 642 of the downlink subframe 620 using correlation-based CRS detection. For example, the UE 604 may compute the correlation between a hypothesized form of a reference signal R₀ 640 or R₁ 642 at a given symbol and a detected form of a reference signal R₀ 640 or R₁ 642 at that given symbol. In one aspect, the hypothesized form of a reference signal R₀ 640 or R₁ 642 may be based on previously detected CRS, such as when the UE 604 detects CRS from the serving base station 602 in a previous subframe (similar to the subframe 620).

In some aspects of correlation-based CRS detection, the UE 604 may estimate a current channel response for the downlink subframe 620 (e.g., in either in the time domain or frequency domain). For example, the UE 604 may estimate the current channel response based on a previous channel response of a previous symbol. Additionally, the UE 604 may estimate a noise power level of one or more symbols in which the UE 604 expects a reference signal R₀ 640 or R₁ 642. The UE 604 may compute a log likelihood ratio (LLR) of a first and a second detection hypotheses based on the estimated current channel response and the estimated noise power level: the first detection hypothesis may correspond to the likelihood that interfering reference signals are present in a given symbol (e.g., symbol 0), and the second detection hypothesis may correspond to the likelihood that interfering reference signals are absent in the given symbol (e.g., symbol 0). The UE 604 may compare the computed LLR to a second threshold. Based on the comparison (e.g., if the LLR meets or exceeds the threshold), the UE 604 may determine whether interfering reference signals occurs in that given symbol (e.g., symbol 0).

In some aspects, the UE 604 may perform additional or alternative operations in order to detect reference signals R₀ 640 and R₁ 642. For example, the UE 604 may apply a whitening filter to the estimated noise and interference covariance of the reference signals R₀ 640 and R₁ 642 for spatial whitening.

Based on whether interfering reference signals are detected in one or more symbols of the IFNC subframe 622, the UE 604 may determine a subframe type of the IFNC subframe 622. For example, the UE 604 may determine that the IFNC subframe 622 is an uplink subframe (e.g., the uplink subframe 420, a TDD uplink subframe) when interfering reference signals are undetected in symbol 0 at port 0 and port 1 of reference signals R₀ 640 and R₁ 642.

In another example, the UE 604 may detect that the IFNC subframe 622 includes interfering reference signals that overlap with symbol 0 of the downlink subframe 620, and may determine that the IFNC subframe 622 is a downlink subframe based on the detected interfering reference signals.

The UE 604 may detect whether there are interfering reference signals in one or more other symbols of the downlink subframe. For example, for normal CP, the UE 604 may detect whether there are interfering reference signals in symbol 4, symbol 7, and/or symbol 11; for extended CP, the UE 604 may detect whether there are interfering reference signals in symbol 3, symbol 9, and/or symbol 12. In one aspect, the UE 604 may detect for interfering reference signals in each symbol in which the UE 604 expects reference signals R₀ 640 or R₁ 642. In another aspect, for normal CP, the UE 604 may infer that interfering reference signals occur in symbol 4 by detecting whether there are interfering reference signals in one of symbol 7 and/or symbol 11. In other words, the UE 604 may detect interfering reference signals in symbol 7 and/or symbol 11, and the UE 604 may infer that interfering reference signals occur in symbol 4 based on the detection of interfering reference signals in symbol 7 and/or symbol 11. For example, referring back to FIG. 4A, when the IFNC subframe 622 is an aspect of the downlink subframe 400, reference signals R₀ 412a or R₁ 412b may occur in symbol 4 when occurring in symbol 7 and/or symbol 11. Therefore, the UE 604 may infer that reference signals R₀ 412a or R₁ 412b occur in symbol 4 when detected in symbol 7 and/or 11. Similarly, the UE 604 may infer that interfering reference signals occur in symbol 7 when the UE 604 detects interfering reference signals in symbol 11. Similarly, for extended CP, the UE 604 may infer that interfering reference signals occur in symbol 3 by detecting whether there are interfering reference signals in one of symbol 9 and/or symbol 12. Referring back to FIG. 4D, when the IFNC subframe 622 is an aspect of the downlink subframe 480 using extended CP, reference signals R₀ 482a or R₁ 482b may occur in symbol 3 when occurring in symbol 9 and/or symbol 12. Therefore, the UE 604 may infer that reference signals R₀ 482a or R₁ 482b occur in symbol 3 when detected in symbol 9 and/or 12. Similarly, the UE 604 may infer that interfering reference signals occur in symbol 9 when the UE 604 detects interfering reference signals in symbol 12.

Referring to FIG. 4C, the IFNC subframe 622 may be an aspect of the MBSFN subframe 450. In such an aspect, the UE 604 may detect interfering reference signals RS₀ 462a or RS₁ 462b in symbol 0, which may overlap with symbol 0 of the downlink subframe 620 carrying reference signals R₁ 640 and R₂ 642. The UE 604 may additionally detect an absence of interfering reference signals in symbol 4 for normal CP or an absence of interfering reference signals in symbol 3 for extended CP. Therefore, the UE 604 may determine that the IFNC subframe 622 is an MBSFN subframe based on detection of the interfering reference signals in symbol 0 and the absence of detection of the interfering reference signals in symbol 4 for normal CP or the absence of detection of the interfering reference signals in symbol 3 for extended CP.

Referring to FIG. 5A, the IFNC subframe 622 may be an aspect of the first special subframe 500. In such an aspect, the UE 604 may detect interfering reference signals RS₀ 512a and RS₁ 512b in symbol 0, which may overlap with symbol 0 of the downlink subframe 620 carrying reference signals R₁ 640 and R₂ 642. Further, the UE 604 may detect interfering reference signals RS₀ 512a and RS₁ 512b in symbol 4 and/or symbol 7. As described, supra, the UE 604 may infer occurrence of interfering reference signals RS₀ 512a and RS_{1 512}b in symbol 4 when the UE 604 detects occurrence of interfering reference signals RS₀ 512a and RS₁ 512b in symbol 7. The UE 604 may detect an absence of interfering reference signals in symbol 11. Therefore, the UE 604 may determine that the IFNC subframe 622 is a special subframe of configuration 7 based on detection of interfering reference signals RS₀ 512a and RS₁ 512b in symbol 0, symbol 4, and symbol 7, and the absence of detection of the interfering reference signals in symbol 11.

Similarly for a special subframe of configuration 7 using extended CP, the UE 604 may detect interfering reference signals RS₀ and RS₁ in symbol 0, which may overlap with symbol 0 of the downlink subframe 620 carrying reference signals R₁ 640 and R₂ 642. Further, the UE 604 may detect interfering reference signals RS₀ and RS₁ in symbol 3. The UE 604 may detect an absence of interfering reference signals in symbol 9 or in symbol 12. Therefore, the UE 604 may determine that the IFNC subframe 622 is a special subframe of configuration 7 using extended CP based on detection of interfering reference signals RS₀ and RS₁ in symbol 0, symbol 3, and the absence of detection of the interfering reference signals in symbols 9 and 12.

Referring to FIG. 5B, the IFNC subframe 622 may be an aspect of the second special subframe 550. In such an aspect, the UE 604 may detect interfering reference signals RS₀ 512a and RS₁ 512b in symbol 0, which may overlap with symbol 0 of the downlink subframe 620 carrying reference signals R₁ 640 and R₂ 642. Further, the UE 604 may detect interfering reference signals RS₀ 512a and RS₁ 512b in symbol 4. The UE 604 may detect an absence of interfering reference signals in symbol 7 and/or symbol 11. Therefore, the UE 604 may determine that the IFNC subframe 622 is a special subframe of configuration 9 based on detection of interfering reference signals RS₀ 512a and RS₁ 512b in symbol 0 and symbol 4, and the absence of detection of the interfering reference signals in symbol 7 and in symbol 11.

Similarly for a special subframe of configuration 3 using extended CP, the UE 604 may detect interfering reference signals RS₀ and RS₁ in symbols 0, 3, and 9, which may overlap with symbols 0, 3, and 9of the downlink subframe 620 carrying reference signals R₁ 640 and R₂ 642. The UE 604 may detect an absence of interfering reference signals in symbol 12. Therefore, the UE 604 may determine that the IFNC subframe 622 is a special subframe of configuration 3 using extended CP based on detection of interfering reference signals RS₀ and RS₁ in symbols 0, 3, and 9, and the absence of detection of the interfering reference signals in symbol 12.

In various aspects, the UE 604 may cancel detected interfering CRS from the received downlink subframe 620 based on the determined subframe type of the second subframe 622. For example, the UE 604 may identify one or more symbols in which the interfering CRS are located, and then the UE 604 may use an interference cancellation algorithm to cancel the interfering CRS in the one or more identified symbols. For example, when the UE 604 determines that the subframe type of the second subframe 622 is a downlink subframe using normal CP, the UE 604 may cancel interfering CRS on symbols 0, 4, 7, and 11. In another example, when the UE 604 determines that the subframe type of the second subframe is a downlink subframe using extended CP, the UE 604 may cancel interfering CRS on symbols 0, 3, 9, and 12. In another example, when the UE 604 determines that the subframe type of the second subframe 622 is MBSFN, the UE may cancel detected interfering CRS in symbol 0. In another example, when the UE 604 determines that the subframe type of the second subframe 622 is a special subframe using normal CP, the UE 604 may cancel detected interfering CRS in symbols 0 and 4 (and potentially 7, depending on the special subframe configuration). In another example, when the UE 604 determines that the subframe type of the second subframe 622 is a special subframe using extended CP, the UE 604 may cancel detected interfering CRS in symbol 0 (and potentially symbols 3 and 9, depending on the special subframe configuration).

In an aspect, the UE 604 may enable one or more receiver features (e.g., data cancellation) based on determining the type of the second subframe 622. For example, the UE 604 may perform data cancellation in one or more symbols of the second subframe 622. In an aspect in which the type of the second subframe 622 is an MB SFN subframe, the UE 604 may perform data cancellation of MB SFN data 466 of the MBSFN subframe 450. In an aspect in which the type of the second subframe 622 is a special subframe, the UE 604 may perform data cancellation, for example, of downlink data in a downlink region 510. The UE may perform different types of interference cancellation (e.g., CRS interference cancellation or data interference cancellation) based at least in part on whether the detected CRS from the IFNC collides with CRS from the serving cell 610. For example, if the CRS of the second subframe 622 from the first IFNC 612 collides with CRS from the downlink subframe 620, the UE 604 may employ CRS interference cancellation. In a further example, if the CRS of the second subframe 622 from the first IFNC 612 does not collide with CRS from the downlink subframe 620, the UE 604 may employ data interference cancellation.

In some aspects, the UE 604 may determine information associated with an IFNC, such as the second IFNC 614. For example, the UE 604 may decode information carried on a PBCH from the second IFNC 614 in order to detect the ports on which CRS are transmitted for the second IFNC 614, and the UE 604 may cancel interfering reference signals from the second IFNC 614 based on the detected ports. In another aspect, the UE 604 may receive and decode a configuration of an IFNC subframe based on network signaling, such as RRC signaling from the serving base station 602.

In one aspect, the UE 604 may receive an information element (e.g., MeasObjectEUTRA::NeighCellConfig) that indicates information regarding the second IFNC 614. Because the UE 604 is provided with configuration information of the IFNC subframe from the second IFNC 614, the UE 604 may perform interference cancellation, such as by subtracting reference signals indicated as configured in the second IFNC 614 from signals carried in the downlink subframe 620. Accordingly, the UE 604 may perform interference cancellation (e.g., cancel interfering CRS) from a third subframe 624 received form the second IFNC 614 without detecting interfering CRS because the UE 604 is provided information indicating the configuration of the third subframe 624. The UE 604 may cancel interfering CRS for the third subframe 624 before detecting interfering CRS of the second subframe 622, for example, because the configuration information of the third subframe 624 is provided to the UE 604.

After the UE 604 performs interference cancellation, the UE 604 may process the downlink subframe 620, e.g., without interference. For example, the UE 604 may use the CRS of the downlink subframe 620 for cell search and initial acquisition associated with the serving cell 610. In another example, the UE 604 may perform downlink channel quality measurements based on the CRS of the downlink subframe 620, and may send one or more downlink channel quality measurements to the serving base station 602. In another example, the UE 604 may perform downlink channel estimation (e.g., for demodulation/detection) based on the CRS of the downlink subframe 620.

In some aspects, the UE 604 may store information associated with the second subframe 622. For example, TDD and/or MBSFN subframe configurations may be semi-static and, therefore, may be valid for future subframes. Accordingly, the UE 604 may store a configuration indicating the type of subframe associated with the first IFNC 612. When the UE 604 receives another downlink subframe from the serving base station 602 that includes an interfering subframe from the first IFNC 612, the UE 604 may access the stored configuration information in order to determine the type of subframe of the interfering subframe. The UE 604 may then perform cancellation of CRS and/or data cancellation based on the type of interfering subframe, e.g., without detecting CRS in each subsequent interfering subframe.

In some aspects, the UE 604 may be configured to detect the bandwidth of CRS transmission from the first IFNC 612. The UE 604 may determine bandwidth of CRS transmission corresponding to a port on a symbol that carries CRS of the second subframe 622 from the first IFNC 612. In some aspects, the UE 604 may estimate the bandwidth of CRS transmission (e.g., over 1.4, 3, 5, 10, 15, and/or 20 MHz). The UE 604 may perform cancellation of CRS from the second subframe 622 in the detected bandwidth.

FIGS. 7A, 7B, and 7C are flowcharts of a method 700 of wireless communication. The method 700 may be performed by a UE (e.g., the UE 104, the UE 604). While the method 700 illustrates a plurality of discrete operations, the present disclosure contemplates aspects in which one or more operations are transposed, omitted, and/or contemporaneously performed.

Beginning first with operation 702, the UE may receive a downlink subframe from a serving base station. The downlink subframe may at least partially overlap with at least a second subframe transmitted by a first IFNC, and the downlink subframe may include interference associated with the at least the second subframe transmitted by the first IFNC. In the context of FIG. 6, the UE 604 may receive, from the serving base station 602, the downlink subframe 620. As described, the downlink subframe 620 may at least partially overlap with the second subframe 622 and may include interference associated with the second subframe 622 transmitted for the first IFNC 612. Further, the downlink subframe may include interference associated with the third subframe 624 transmitted for the second IFNC 614.

At operation 704, the UE may receive information indicating a subframe configuration associated with a second IFNC. The UE may receive this information via RRC signaling. For example, the UE may receive at least one information element indicating a subframe configuration associated with the second IFNC, and the UE may determine the subframe configuration associated with the second IFNC based on the received information. In the context of FIG. 6, the UE 604 may receive information indicating a configuration of the third subframe 624 associated with the second IFNC 614.

At operation 706, the UE may cancel interfering CRS associated with the second IFNC based on the received information. For example, the UE may select an algorithm used for interference cancellation, and the UE may use the algorithm with the subframe configuration information to perform CRS interference cancellation for a subframe received from the second IFNC that interferes with the downlink subframe received from the serving base station. In one aspect, the UE may identify the interfering CRS carried in at least one resource based on the received information, and the UE may subtract the interfering CRS from the signal carried in at least one resource. In the context of FIG. 6, the UE 604 may cancel interfering CRS associated with the third subframe 624 received from the second IFNC 614.

At operation 708, the UE may detect whether there are interfering CRS in one or more symbols of the second subframe transmitted by the first IFNC. For example, the UE may detect a signal on one or more symbols of the second subframe, and the UE may determine whether the signal is a CRS on at least one of ports 0 or 1, which may interfere with CRS included in the downlink subframe. In the context of FIG. 6, the UE 604 may detect whether there are interfering CRS in one or more symbols of the second subframe 622, which may interfere with the received downlink subframe 620.

In an aspect, operation 708 may include operation 732 and operation 734. At operation 732, the UE may detect whether there are interfering CRS by measuring an SNR associated with at least a first symbol of the second subframe. For example, the UE may detect interfering CRS in the first symbol and the UE may measure an SNR associated with that first symbol. In the context of FIG. 6, the UE 604 may measure an SNR associated with a first symbol of the one or more symbols. For example, the UE 604 may measure the SNR of R₀ 640 and/or R₁ 642 on symbol 0. Referring to FIG. 4D, the UE 604 may measure the SNR on symbols 3, 9, and/or 12, at which R₀ 482a and/or R₁ 482b of the downlink subframe 480 may collide with R₀ 640 and/or R₁ 642 of the downlink subframe 620. Referring to FIG. 5A, the UE 604 may measure the SNR on symbols 4 and/or 7, at which R₀ 512a and/or R₁ 512b of the first special subframe 500 may collide with R₀ 640 and/or R₁ 642 of the downlink subframe 620.

At operation 734, the UE may compare the measured SNR to a threshold. For example, the UE may compare the measured SNR to a predetermined threshold, and the UE may determine whether the measured SNR meets or exceeds the predetermined threshold. Based on the comparison, the UE may determine whether there are interfering CRS in the first symbol. For example, if the UE determines that the measured SNR meets or exceeds the threshold, then the UE may determine that interfering CRS are detected in the first symbol. In the context of FIG. 6, the UE 604 may compare the measured SNR to a threshold in order to determine if interfering CRS are detected.

In one aspect of operations 732 and 734, the UE may measure a first SNR for CRS on a first port and measure a second SNR for CRS on a second port. The UE may combine (e.g., add) the first SNR and the second SNR, and the UE may compare the combination (e.g., sum) of the first and second SNRs to a threshold in order to determine if interfering CRS are detected. In the context of FIG. 6, the UE 604 may measure a first SNR on R₀ 640 (e.g., in symbol 0) and measure a second SNR on R₁ 642 (e.g., in symbol 0). The UE 604 may combine the first and second SNRs and compare the combination to a threshold in order to determine if interfering CRS are detected in at least one symbol on the ports 0 and 1.

At operation 710, the UE may determine a subframe type of the second subframe based on whether interfering CRS are detected in one or more symbols of the second subframe. For example, the UE may identify one or more symbols of the second subframe in which CRS are detected, and then the UE may identify a subframe type that corresponds to CRS located at the one or more identified symbols. For example, the UE may determine that the subframe type of the second subframe is uplink, downlink using normal CP, downlink using extended CP, MBSFN, a special subframe using normal CP, a special subframe using extended CP, and/or another type of subframe. In the context of FIG. 6, the UE 604 may determine the type of subframe of the second subframe 622 based on whether interfering CRS are detected in one or more symbols of the second subframe 622.

At operation 712, the UE may cancel detected interfering CRS from the received downlink subframe based on the determined subframe type of the second subframe. For example, the UE may identify one or more symbols in which the interfering CRS are located, and then the UE may use an interference cancellation algorithm to cancel the interfering CRS in the one or more identified symbols. For example, when the UE determines that the subframe type of the second subframe is a downlink subframe using normal CP, the UE may cancel interfering CRS on symbols 0, 4, 7, and 11. In another example, when the UE determines that the subframe type of the second subframe is a downlink subframe using extended CP, the UE may cancel interfering CRS on symbols 0, 3, 9, and 12. In another example, when the UE determines that the subframe type of the second subframe is MBSFN, the UE may cancel detected interfering CRS in symbol 0. In another example, when the UE determines that the subframe type of the second subframe is a special subframe using normal CP, the UE may cancel detected interfering CRS in symbols 0 and 4 (and potentially 7, depending on the special subframe configuration). In another example, when the UE determines that the subframe type of the second subframe is a special subframe using extended CP, the UE may cancel detected interfering CRS in symbol 0 (and potentially symbols 3 and 9, depending on the special subframe configuration). In the context of FIG. 6, the UE 604 may cancel detected interfering CRS from the received downlink subframe 620 based on the determined subframe type of the second subframe 622.

In an aspect, operation 712 may include operation 736. At operation 736, the UE may cancel interfering CRS in at least symbol 4 when interfering CRS are located in at least one of symbols 7 or 11. For example, if the UE detects interfering CRS in symbol 11, then the UE may determine that the type of the second subframe is a downlink subframe using normal CP, and therefore, the UE may infer that interfering CRS also occurs in at least symbol 4. The UE may cancel all interfering CRS—e.g., the UE may cancel CRS located on symbols 0, 4, 7, and 11 (e.g., if CRS are detected on at least symbol 11). The UE may perform one or more interference cancellation operations (e.g., CRS interference cancellation or data interference cancellation) based at least in part on whether the CRS from an IFNC collides with CRS from the serving cell of the UE. For example, if the CRS from the IFNC collides with CRS from a serving cell of the UE, then the UE may use CRS interference cancellation. In a further example, if the CRS from the IFNC does not collide with CRS from the serving cell, then the UE may use data interference cancellation.

In the context of FIG. 6 for normal CP, the UE 604 may cancel interfering CRS in at least symbol 4 when interfering CRS are detected in at least symbol 11. The UE 604 may cancel all interfering CRS—e.g., the UE may cancel CRS located on symbols 0, 4, 7, and 11 (e.g., if CRS are detected on at least symbol 11). The UE 604 may perform different types of interference cancellation (e.g., CRS interference cancellation or data interference cancellation) based at least in-part on whether the CRS from the IFNC 612 collides with CRS from the serving cell 610. For example, if the CRS from the IFNC 612 collides with CRS from the serving cell 610, the UE 604 may employ CRS interference cancellation. In a further example, if the CRS from the IFNC 612 does not collide with CRS from the serving cell 610 the UE 604 may employ data interference cancellation.

In an aspect, operation 712 may include operation 738. At operation 738, the UE may cancel interfering CRS in at least symbol 3 when interfering CRS are located in at least one of symbols 9 or 12. For example, if the UE detects interfering CRS in symbol 12, then the UE may determine that the type of the second subframe is a downlink subframe using extended CP, and therefore, the UE may infer that interfering CRS also occurs in at least symbol 3. The UE may cancel all interfering CRS—e.g., the UE may cancel CRS located on symbols 0, 3, 9, and 12 (e.g., if CRS are detected on at least symbol 12). The UE may perform one or more interference cancellation operations (e.g., CRS interference cancellation or data interference cancellation) based at least in part on whether the CRS from an IFNC collides with CRS from the serving cell of the UE. For example, if the CRS from the IFNC collides with CRS from a serving cell of the UE, then the UE may use CRS interference cancellation. In a further example, if the CRS from the IFNC does not collide with CRS from the serving cell, then the UE may use data interference cancellation.

In the context of FIG. 6 for extended CP, the UE 604 may cancel interfering CRS in at least symbol 3 when interfering CRS are detected in at least symbol 12. The UE 604 may cancel all interfering CRS—e.g., the UE may cancel CRS located on symbols 0, 3, 9, and 12 (e.g., if CRS are detected on at least symbol 12). The UE 604 may perform different types of interference cancellation (e.g., CRS interference cancellation or data interference cancellation) based at least in-part on whether the CRS from the IFNC 612 collides with CRS from the serving cell 610. For example, if the CRS from the IFNC 612 collides with CRS from the serving cell 610, the UE 604 may employ CRS interference cancellation. In a further example, if the CRS from the IFNC 612 does not collide with CRS from the serving cell 610 the UE 604 may employ data interference cancellation.

At operation 714, the UE may perform data cancellation associated with the second subframe based on the location of the CRS in the second subframe. For example, the UE may identify one or more symbols of the second subframe that carry data. The UE may then employ an interference algorithm (e.g., a receiver feature) that cancels data carried in the one or more symbols of the second subframe in order to mitigate interference affecting the received downlink subframe. In the context of FIG. 6, the UE 604 may perform, on the received downlink subframe 620, data cancellation associated with the second subframe 622 based on the location of the CRS in the second subframe 622.

In one aspect of the method 700, operation 708 may include operation 720. At operation 720, the UE may determine whether there are interfering CRS in symbol 0 of the second subframe. For example, the UE may detect a signal on symbol 0 of the second subframe, and the UE may determine whether the signal is a CRS on at least one of ports 0 or 1, which may interfere with CRS included in the downlink subframe. In the context of FIG. 6, the UE 604 may determine whether there are interfering CRS in symbol 0 of the second subframe 622 (e.g., the second subframe 622 may be an aspect of the downlink subframe illustrated in FIG. 2A or the uplink subframe illustrated in FIG. 2C).

In connection with operation 720, operation 710 may include operation 726. If the UE determines that there are interfering CRS in symbol 0 of the second subframe, as shown at operation 720, then the UE may determine that the second subframe is a downlink subframe, as illustrated at operation 726. Alternatively, the UE may determine that the second subframe is an uplink subframe if interfering CRS are undetected in symbol 0 of the second subframe. In the context of FIG. 6, the UE 604 may determine that the second subframe 622 is a downlink subframe when the UE 604 detects interfering CRS in symbol 0 of the second subframe 622.

In one aspect of the method 700, operation 708 may include operation 722. At operation 722, the UE may determine whether there are interfering CRS in symbol 4 of the second subframe using normal CP or whether there are interfering CRS in symbol 3 of the second subframe using extended CP. For example, the UE may detect a signal on symbol 4 of the second subframe using normal CP or symbol 3 of the second subframe using extended CP, and the UE may determine whether the signal is a CRS on at least one of ports 0 or 1. However, a CRS on one of ports 0 or 1 may be absent in symbol 4, as is the case with MBSFN subframes. In the context of FIG. 6, the UE 604 may determine whether there are interfering CRS in symbol 4 of the second subframe 622 using normal CP or whether there are interfering CRS in symbol 3 of the second subframe 622 using extended CP. For example, the second subframe 622 may be an aspect of the MBSFN subframe 450 of FIG. 4C, and the UE 604 may detect R₀ 412a and/or R₁ 412b in symbol 0 but not symbol 4 or symbol 3 of the MBSFN subframe 450.

In connection with operation 722, operation 710 may include operation 728. If the UE determines the absence of interfering CRS in symbol 4 of the second subframe using normal CP or determines the absence of interfering CRS in symbol 3 of the second subframe using extended CP, as shown at operation 722, then the UE may determine that the second subframe is an MB SFN subframe, as illustrated at operation 726. In the context of FIG. 6, the UE 604 may determine that the second subframe 622 is an MBSFN subframe when the UE 604 does not detect interfering CRS in symbol 4 of the second subframe 622 using normal CP or does not detect interfering CRS in symbol 3 of the second subframe 622 using extended CP. For example, the second subframe 622 may be an aspect of the MBSFN subframe 450 of FIG. 4C, and the UE 604 may determine that the second subframe 622 includes the MBSFN subframe 450 when R₀ 412a and/or R₁ 412b are detected in symbol 0 but not symbol 4 or symbol 3 of the MBSFN subframe 450.

In one aspect of the method 700, operation 708 may include operation 724. At operation 724, the UE may determine whether there are interfering CRS in at least one of symbols 4, 7, or 11 of the second subframe using normal CP, or may determine whether there are interfering CRS in at least one of symbols 3, 9, or 12 of the second subframe using extended CP. For example, the UE may detect a signal on at least one of symbols 4, 7, or 11 of the second subframe using normal CP, and the UE may determine whether the signal is a CRS on at least one of ports 0 or 1, which may interfere with CRS included in the downlink subframe. Similarly, the UE may detect a signal on at least one of symbols 3, 9, or 12 of the second subframe using extended CP, and the UE may determine whether the signal is a CRS on at least one of ports 0 or 1, which may interfere with CRS included in the downlink subframe. In the context of FIG. 6, the UE 604 may determine whether there are interfering CRS in at least one of symbols 4, 7, or 11 of the second subframe 622 using normal CP. For example, the second subframe 622 may be an aspect of the first special subframe 500 of FIG. 5A, and the UE 604 may detect R₀ 512a and/or R₁ 512b in symbols 4 or 7 but not symbol 11 of the first special subframe 500. Similarly, the second subframe 622 may be an aspect of the second special subframe 550 of FIG. 5B, and the UE 604 may detect R₀ 512a and/or R₁ 512b in symbol 4 but not symbols 7 and 11 of the first special subframe 500. In another example, the UE 604 may determine whether there are interfering CRS in at least one of symbols 3, 9, or 12 of the second subframe 622 using extended CP. For example, the second subframe 622 may be an aspect of the downlink subframe 480 using extended CP of FIG. 4D, and the UE 604 may detect R₀ 482a and/or R₁ 482b in symbols 3 or 9 but not symbol 12 of the downlink subframe 480 using extended CP.

In connection with operation 724, operation 710 may include operation 730. At operation 730, the UE may determine that the second subframe is a special subframe when interfering CRS are located in symbols 4 and 7 but not symbol 11 for normal CP, or when interfering CRS are located in symbol 4 but not symbols 7 or 11 for normal CP, or when interfering CRS are located in symbols 3 and 9 but not symbol 12 for extended CP, or when interfering CRS are located in symbol 3 but not symbols 9 or 12 for extended CP. In the context of FIG. 6, the UE 604 may determine that the second subframe 622 is a special subframe using normal CP when the UE 604 detects interfering CRS in at least symbol 4 of the second subframe 622 but does not detect interfering CRS in at least symbol 11 of the second subframe 622. For example, the second subframe 622 may be an aspect of the first special subframe 500 of FIG. 5A, and the UE 604 may determine that the second subframe 622 includes the first special subframe 500 when R₀ 512a and/or R₁ 512b are detected in symbols 4 and 7 but not symbol 11 of the first special subframe 500. Similarly, the second subframe 622 may be an aspect of the second special subframe 550 of FIG. 5B, and the UE 604 may determine that the second subframe 622 includes the second special subframe 550 when R₀ 512a and/or R₁ 512b are detected in symbol 4 but not symbols 7 and 11 of the second special subframe 550. Similarly, the second subframe 622 may be an aspect of a special subframe of configuration 7 using extended CP, and the UE 604 may determine that the second subframe 622 includes the special subframe of configuration 7 using extended CP when R₀ and/or R₁ are detected in symbol 3 but not symbols 9 and 12.

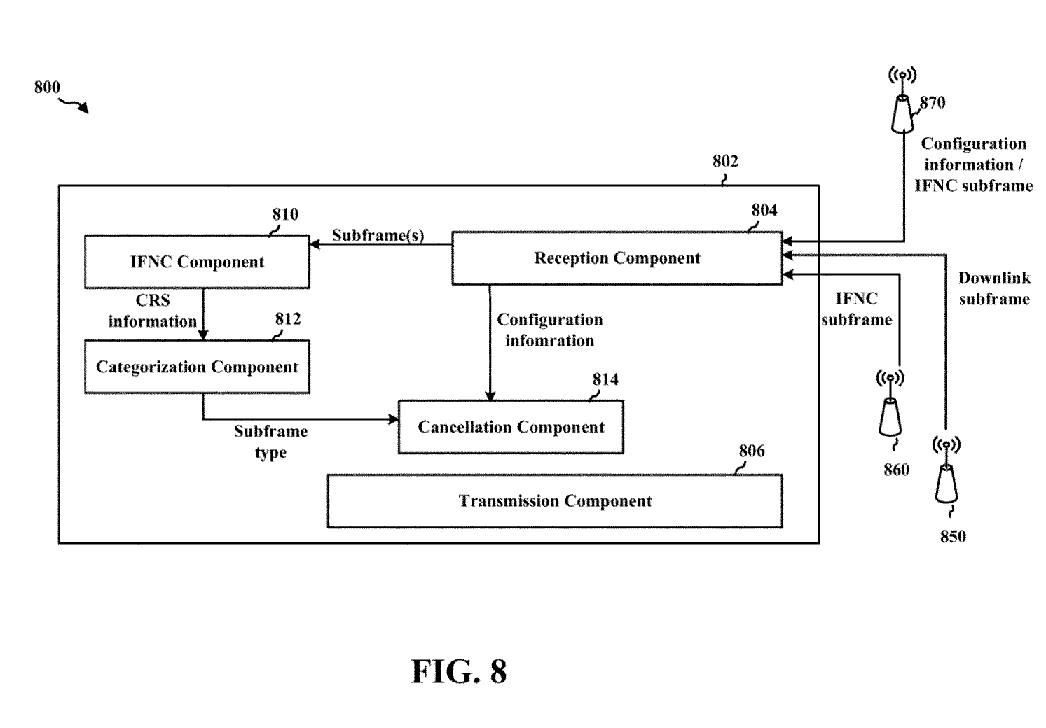

FIG. 8 is a conceptual data flow diagram 800 illustrating the data flow between different means/components in an exemplary apparatus 802. The apparatus may be a UE. The apparatus includes a reception component 804 that is configured to receive signals and a transmission component 806 that is configured to transmit signals.

The reception component 804 may receive a downlink subframe from a serving base station 850, and the downlink subframe may include interference associated with a second subframe transmitted by an IFNC 860.

The IFNC component 810 may detect whether there are interfering CRS in one or more symbols of the second subframe transmitted by the IFNC 860. The categorization component 812 may determine, based on whether interfering CRS are detected in the one or more symbols of the second subframe, a subframe type of the second subframe transmitted by the IFNC 860. The cancellation component 814 may cancel detected interfering CRS of the second subframe from the received downlink subframe based on the determined subframe type of the second subframe transmitted by the IFNC 860.

In an aspect, the IFNC component 810 may detect whether there are interfering CRS in one or more symbols of the second subframe by determining whether there are interfering CRS in symbol 0 of the second subframe. The categorization component 812 may determine the subframe type of the second subframe based on whether interfering CRS are detected in the one or more symbols of the second subframe by determining that the second subframe is a downlink subframe when interfering CRS are located in the symbol 0 of the second subframe.

In an aspect, the IFNC component 810 may detect whether there are interfering CRS in one or more symbols of the second subframe by determining whether there are interfering CRS in symbol 4 of the second subframe using normal CP or by determining whether there are interfering CRS in symbol 3 of the second subframe using extended CP. The categorization component 812 may determine the subframe type of the second subframe based on whether interfering CRS are detected in the one or more symbols of the second subframe by determining that the second subframe is an MBSFN subframe when interfering CRS are not located in the symbol 4 of the second subframe using normal CP or not located in symbol 3 of the second subframe using extended CP (but is located in symbol 0 of the second subframe). In an aspect, the cancellation component 814 may cancel detected interfering CRS of the second subframe from the received downlink subframe based on the determination that the second subframe is an MBSFN subframe.

In an aspect, the IFNC component 810 may detect whether there are interfering CRS in one or more symbols of the second subframe by determining whether there are interfering CRS in at least one of symbols 4, 7, and/or 11 of the second subframe using normal CP or by determining whether there are interfering CRS in at least one of symbols 3, 9, and/or 12 of the second subframe using extended CP. The categorization component 812 may determine that the second subframe is a special subframe when interfering CRS are located in symbols 4 and 7 but not symbol 11 of the second subframe using normal CP, or interfering CRS are located in symbol 4 but not symbols 7 and 11 of the second subframe using normal CP, or interfering CRS are located in symbols 3 and 9 but not symbol 12 of the second subframe using extended CP, or interfering CRS are located in symbol 3 but not symbols 9 and 12 of the second subframe using extended CP. In an aspect, the cancellation component 814 may cancel detected interfering CRS from the second subframe based on the determination that the second subframe is a special subframe. For normal CP, the cancellation component 814 may cancel the detected interfering CRS from the received downlink subframe based on the determined subframe type of the second subframe by canceling interfering CRS in symbol 4 when interfering CRS are located in the at least one or symbols 7 or 11. For extended CP, the cancellation component 814 may cancel the detected interfering CRS from the received downlink subframe based on the determined subframe type of the second subframe by canceling interfering CRS in symbol 3 when interfering CRS are located in the at least one or symbols 9 or 12.

In an aspect, the IFNC component 810 may detect whether there are interfering CRS in one or more symbols of the second subframe by measuring an SNR associated with at least a first symbol of the one or more symbols and comparing the measured SNR associated with the first symbol to a threshold. In an aspect, the measured SNR may be a combination of at least a first SNR for CRS on a first port and a second SNR for CSR on a second port.

In an aspect, the cancellation component 814 may perform, on the received downlink subframe, data cancellation associated with the second subframe based on the location of the CRS in the second subframe.

In an aspect, the cancellation component 814 may receive information indicating a subframe configuration associated with a second IFNC 870. The cancellation component 814 may cancel, from the received downlink subframe, interfering CRS associated with the second IFNC 870 based on the received information indicating the subframe configuration associated with the second IFNC 870.

The apparatus may include additional components that perform each of the blocks of the algorithm in the aforementioned flowcharts of FIGS. 7A, 7B, and 7C. As such, each block in the aforementioned flowcharts of FIGS. 7A, 7B, and 7C may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

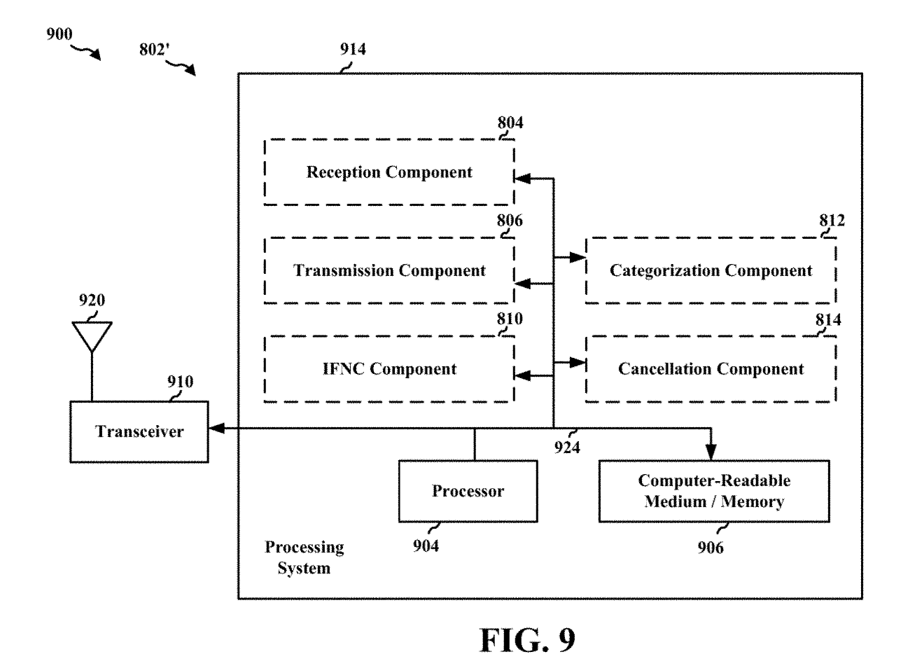

FIG. 9 is a diagram 900 illustrating an example of a hardware implementation for an apparatus 802′ employing a processing system 914. The processing system 914 may be implemented with a bus architecture, represented generally by the bus 924. The bus 924 may include any number of interconnecting buses and bridges depending on the specific application of the processing system 914 and the overall design constraints. The bus 924 links together various circuits including one or more processors and/or hardware components, represented by the processor 904, the components 804, 806, 810, 812, 814, and the computer-readable medium/memory 906. The bus 924 may also link various other circuits such as timing sources, peripherals, voltage regulators, and power management circuits, which are well known in the art, and therefore, will not be described any further.

The processing system 914 may be coupled to a transceiver 910. The transceiver 910 is coupled to one or more antennas 920. The transceiver 910 provides a means for communicating with various other apparatus over a transmission medium. The transceiver 910 receives a signal from the one or more antennas 920, extracts information from the received signal, and provides the extracted information to the processing system 914, specifically the reception component 804. In addition, the transceiver 910 receives information from the processing system 914, specifically the transmission component 806, and based on the received information, generates a signal to be applied to the one or more antennas 920. The processing system 914 includes a processor 904 coupled to a computer-readable medium/memory 906. The processor 904 is responsible for general processing, including the execution of software stored on the computer-readable medium/memory 906. The software, when executed by the processor 904, causes the processing system 914 to perform the various functions described supra for any particular apparatus. The computer-readable medium/memory 906 may also be used for storing data that is manipulated by the processor 904 when executing software. The processing system 914 further includes at least one of the components 804, 806, 810, 812, 814. The components may be software components running in the processor 904, resident/stored in the computer readable medium/memory 906, one or more hardware components coupled to the processor 904, or some combination thereof. The processing system 914 may be a component of the UE 350 and may include the memory 360 and/or at least one of the TX processor 368, the RX processor 356, and the controller/processor 359.

In one configuration, the apparatus 802/802′ for wireless communication includes means for receiving a downlink subframe from a serving base station, the downlink subframe at least partially overlapping with a second subframe transmitted by an IFNC. The apparatus 802/802′ may include means for detecting whether there are interfering CRS in one or more symbols of the second subframe. The apparatus 802/802′ may include means for determining, based on whether interfering CRS are detected in the one or more symbols of the second subframe, a subframe type of the second subframe. The apparatus 802/802′ may include means for canceling detected interfering CRS from the received downlink subframe based on the determined subframe type of the second subframe.

In an aspect, the means for detecting whether there are interfering CRS in one or more symbols of the second subframe is configured to determine whether there are interfering CRS in symbol zero (0) of the second subframe, and the means for determining the subframe type is configured to determine that the second subframe is a downlink subframe when interfering CRS are located in the symbol 0 of the second subframe.

In an aspect, the means for detecting whether there are interfering CRS in one or more symbols of the second subframe further is configured to determine whether there are interfering CRS in symbol four (4) of the second subframe for normal CP or interfering CRS in symbol three (3) of the second subframe for extended CP, and the means for determining the subframe type is configured to determine that the second subframe is a MBSFN subframe when interfering CRS are not located in the symbol 4 of the second subframe for normal CP or interfering CRS are not located in the symbol 3 of the second subframe for extended CP.

In an aspect, the detected interfering CRS from the second subframe are canceled from the received subframe based on the determining that the second subframe is an MB SFN subframe.

In an aspect, the means for detecting whether there are interfering CRS in one or more symbols of the second subframe further is configured to determine whether there are interfering CRS in at least one of symbols four (4), seven (7), or eleven (11) of the second subframe for normal CP or interfering CRS in at least one of symbols three (3), nine (9), or twelve (12) of the second subframe for extended CP, and the means for determining the subframe type is configured to determine that the second subframe is a special subframe when interfering CRS are located in the symbols 4 and 7 and not located in symbol 11 of the second subframe for normal CP, or interfering CRS are located in the symbol 4 and not located in symbols 7 and 11 of the second subframe for normal CP, or interfering CRS are located in the symbols 3 and 9 and not located in symbol 12 of the second subframe for extended CP, or interfering CRS are located in the symbol 3 and not located in symbols 9 and 12 of the second subframe for extended CP.

In an aspect, the detected interfering CRS from the second subframe are canceled from the received subframe based on determining that the second subframe is a special subframe.

In an aspect, the means for canceling the detected interfering CRS from the received downlink subframe based on the determined subframe type of the second subframe is configured to cancel interfering CRS in symbol 4 when interfering CRS are located in the at least one of symbols 7 or 11 of the second subframe for normal CP, or cancel interfering CRS in symbol 3 when interfering CRS are located in the at least one of symbols 9 or 12 of the second subframe for extended CP.

In an aspect, the means for detecting whether there are interfering CRS in one or more symbols of the second subframe is configured to measure an SNR associated with at least a first symbol of the one or more symbols, and compare the measured SNR associated with the first symbol to a threshold. In an aspect, the measured SNR includes a combination of at least a first SNR for CRS on a first port and a second SNR for CRS on a second port.

The apparatus 802/802′ may further include means for performing, on the received downlink subframe, data cancellation associated with the second subframe based on the location of the CRS in the second subframe.

In an aspect, the apparatus 802/802′ may further include means for receiving information indicating a subframe configuration associated with a second IFNC, and means for canceling, from the received downlink subframe, interfering CRS associated with the second IFNC based on the received information indicating the subframe configuration associated with the second IFNC.

The aforementioned means may be one or more of the aforementioned components of the apparatus 802 and/or the processing system 914 of the apparatus 802′ configured to perform the functions recited by the aforementioned means. As described supra, the processing system 914 may include the TX Processor 368, the RX Processor 356, and the controller/processor 359. As such, in one configuration, the aforementioned means may be the TX Processor 368, the RX Processor 356, and the controller/processor 359 configured to perform the functions recited by the aforementioned means.

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method of wireless communication for a user equipment (UE), the method comprising:
receiving a downlink subframe from a serving base station, the downlink subframe at least partially overlapping with a second subframe transmitted by an intra-frequency neighboring cell (IFNC);
detecting whether there are interfering cell-specific reference signals (CRS) in one or more symbols of the second subframe;
determining, based on whether interfering CRS are detected in the one or more symbols of the second subframe, a subframe type of the second subframe; and
canceling detected interfering CRS from the received downlink subframe based on the determined subframe type of the second subframe.

2. The method of claim 1, wherein the detecting whether there are interfering CRS in one or more symbols of the second subframe comprises:
determining whether there are interfering CRS in symbol zero (0) of the second subframe; and
wherein the determining the subframe type comprises:
determining that the second subframe is a downlink subframe when interfering CRS are located in the symbol 0 of the second subframe.

3. The method of claim 2, wherein the detecting whether there are interfering CRS in one or more symbols of the second subframe further comprises:
determining whether there are interfering CRS in symbol four (4) of the second subframe for normal cyclic prefix (CP) or whether there are interfering CRS in symbol three (3) of the second subframe for extended CP; and
wherein the determining the subframe type comprises:
determining that the second subframe is a multicast-broadcast single-frequency network (MBSFN) subframe when interfering CRS are not located in the symbol 4 of the second subframe for normal CP or when interfering CRS are not located in the symbol 3 of the second subframe for extended CP.

4. The method of claim 3, wherein the detected interfering CRS from the second subframe are canceled from the received downlink subframe based on the determining that the second subframe is an MBSFN subframe.

5. The method of claim 2, wherein the detecting whether there are interfering CRS in one or more symbols of the second subframe further comprises:
determining whether there are interfering CRS in at least one of symbols four (4), seven (7), or eleven (11) of the second subframe for normal cyclic prefix (CP) or whether there are interfering CRS in at least one of symbols three (3), nine (9), or twelve (12) of the second subframe for extended CP; and wherein the determining the subframe type comprises:
determining that the second subframe is a special subframe when
interfering CRS are located in the symbols 4 and 7 and not located in the symbol 11 of the second subframe for normal CP,
interfering CRS are located in the symbol 4 and not located in the symbols 7 and 11 of the second subframe for normal CP,
interfering CRS are located in the symbols 3 and 9 and not located in the symbol 12 of the second subframe for extended CP, or
interfering CRS are located in the symbol 3 and not located in the symbols 9 and 12 of the second subframe for extended CP.

6. The method of claim 5, wherein the detected interfering CRS from the second subframe are canceled from the received downlink subframe based on determining that the second subframe is a special subframe.

7. The method of claim 5, wherein the canceling the detected interfering CRS from the received downlink subframe based on the determined subframe type of the second subframe comprises:
canceling interfering CRS in the symbol 4 when interfering CRS are located in the at least one of symbols 7 or 11 of the second subframe for normal CP or canceling interfering CRS in the symbol 3 when interfering CRS are located in the at least one of symbols 9 or 12 of the second subframe for extended CP.

8. The method of claim 1, wherein the detecting whether there are interfering CRS in one or more symbols of the second subframe comprises:
measuring a signal-to-noise ratio (SNR) associated with at least a first symbol of the one or more symbols; and
comparing the measured SNR associated with the first symbol to a threshold.

9. The method of claim 8, wherein the measured SNR comprises a combination of at least a first SNR for CRS on a first port and a second SNR for CRS on a second port.

10. The method of claim 1, further comprising:
performing, on the received downlink subframe, data cancellation associated with the second subframe based on a location of the CRS in the second subframe.

11. The method of claim 1, further comprising:
receiving information indicating a subframe configuration associated with a second IFNC; and
canceling, from the received downlink subframe, interfering CRS associated with the second IFNC based on the received information indicating the subframe configuration associated with the second IFNC.

12. An apparatus for wireless communication, comprising:
means for receiving a downlink subframe from a serving base station, the downlink subframe at least partially overlapping with a second subframe transmitted by an intra-frequency neighboring cell (IFNC);
means for detecting whether there are interfering cell-specific reference signals (CRS) in one or more symbols of the second subframe;
means for determining, based on whether interfering CRS are detected in the one or more symbols of the second subframe, a subframe type of the second subframe; and
means for canceling detected interfering CRS from the received downlink subframe based on the determined subframe type of the second subframe.

13. The apparatus of claim 12, wherein the means for detecting whether there are interfering CRS in one or more symbols of the second subframe is configured to determine whether there are interfering CRS in symbol zero (0) of the second subframe; and wherein the means for determining the subframe type is configured to determine that the second subframe is a downlink subframe when interfering CRS are located in the symbol 0 of the second subframe.

14. The apparatus of claim 13, wherein the means for detecting whether there are interfering CRS in one or more symbols of the second subframe further is configured to:
determine whether there are interfering CRS in symbol four (4) of the second subframe for normal cyclic prefix (CP) or whether there are interfering CRS in symbol (3) of the second subframe for extended CP; and wherein
the means for determining the subframe type is configured to:
determine that the second subframe is a multicast-broadcast single-frequency network (MBSFN) subframe when interfering CRS are not located in the symbol 4 of the second subframe for normal CP or when interfering CRS are not located in the symbol 3 of the second subframe for extended CP.

15. The apparatus of claim 14, wherein the detected interfering CRS from the second subframe are canceled from the received downlink subframe based on the determining that the second subframe is an MBSFN subframe.

16. The apparatus of claim 13, wherein the means for detecting whether there are interfering CRS in one or more symbols of the second subframe further is configured to:
determine whether there are interfering CRS in at least one of symbols four (4), seven (7), or eleven (11) of the second subframe for normal cyclic prefix (CP) or whether there are interfering CRS in at least one of symbols three (3), nine (9), or twelve (12) of the second subframe for extended CP, and wherein
the means for determining the subframe type is configured to:
determine that the second subframe is a special subframe when interfering CRS are located in the symbols 4 and 7 and not located in the symbol 11 of the second subframe for normal CP, interfering CRS are located in the symbol 4 and not located in symbols 7 and 11 of the second subframe for normal CP, interfering CRS are located in the symbols 3 and 9 and not located in the symbol 12 of the second subframe for extended CP, or interfering CRS are located in the symbol 3 and not located in the symbols 9 and 12 of the second subframe for extended CP.

17. The apparatus of claim 16, wherein the detected interfering CRS from the second subframe are canceled from the received downlink subframe based on determining that the second subframe is a special subframe.

18. The apparatus of claim 16, wherein the means for canceling the detected interfering CRS from the received downlink subframe based on the determined subframe type of the second subframe is configured to cancel interfering CRS in the symbol 4 when interfering CRS are located in the at least one of symbols 7 or 11 of the second subframe for normal CP, or to cancel interfering CRS in the symbol 3 when the interfering CRS are located in the at least one of symbols 9 or 12 of the second subframe for extended CP.

19. The apparatus of claim 12, wherein the means for detecting whether there are interfering CRS in one or more symbols of the second subframe is configured to:
measure a signal-to-noise ratio (SNR) associated with at least a first symbol of the one or more symbols; and
compare the measured SNR associated with the first symbol to a threshold.

20. The apparatus of claim 19, wherein the measured SNR comprises a combination of at least a first SNR for CRS on a first port and a second SNR for CRS on a second port.

21. The apparatus of claim 12, further comprising:
means for performing, on the received downlink subframe, data cancellation associated with the second subframe based on a location of the CRS in the second subframe.

22. The apparatus of claim 12, further comprising:
means for receiving information indicating a subframe configuration associated with a second IFNC; and
means for canceling, from the received downlink subframe, interfering CRS associated with the second IFNC based on the received information indicating the subframe configuration associated with the second IFNC.

23. An apparatus for wireless communication, comprising:
a memory; and
at least one processor coupled to the memory and configured to:
receive a downlink subframe from a serving base station, the downlink subframe at least partially overlapping with a second subframe transmitted by an intra-frequency neighboring cell (IFNC);
detect whether there are interfering cell-specific reference signals (CRS) in one or more symbols of the second subframe;
determine, based on whether interfering CRS are detected in the one or more symbols of the second subframe, a subframe type of the second subframe; and
cancel detected interfering CRS from the received downlink subframe based on the determined subframe type of the second subframe.

24. The apparatus of claim 23, wherein the detection of whether there are interfering CRS in one or more symbols of the second subframe comprises to:
determine whether there are interfering CRS in symbol zero (0) of the second subframe, and wherein the determination of the subframe type is comprises to:
determine that the second subframe is a downlink subframe when interfering CRS are located in the symbol 0 of the second subframe.

25. The apparatus of claim 24, wherein the detection of whether there are interfering CRS in one or more symbols of the second subframe comprises to:
determine whether there are interfering CRS in symbol four (4) of the second subframe for normal cyclic prefix (CP) or whether there are interfering CRS in symbol three (3) of the second subframe for extended CP; and wherein the determination of the subframe type is comprises to:
determine that the second subframe is a multicast-broadcast single-frequency network (MBSFN) subframe when interfering CRS are not located in the symbol 4 of the second subframe for normal CP or when interfering CRS are not located in the symbol 3 of the second subframe for extended CP.

26. The apparatus of claim 24, wherein the detection of whether there are interfering CRS in one or more symbols of the second subframe comprises to:
determine whether there are interfering CRS in at least one of symbols four (4), seven (7), or eleven (11) of the second subframe for normal cyclic prefix (CP) or whether there are interfering CRS in at least one of symbols three (3), nine (9), or twelve (12) of the second subframe for extended CP, and wherein the determination of the subframe type comprises to:
determine that the second subframe is a special subframe when interfering CRS are located in the symbols 4 and 7 and not located in the symbol 11 of the second subframe for normal CP, interfering CRS are located in the symbol 4 and not located in symbols 7 and 11 of the second subframe for normal CP, interfering CRS are located in symbols 3 and 9 and not located in the symbol 12 of the second subframe for extended CP, or interfering CRS are located in the symbol 3 and not located in the symbols 9 and 12 of the second subframe for extended CP.

27. The apparatus of claim 26, wherein the cancellation of the detected interfering CRS from the received downlink subframe based on the determined subframe type of the second subframe comprises to:
cancel interfering CRS in the symbol 4 when interfering CRS are located in the at least one of symbols 7 or 11 of the second subframe for normal CP, or cancel interfering CRS in the symbol 3 when interfering CRS are located in the at least one of symbols 9 or 12 of the second subframe for extended CP.

28. The apparatus of claim 23, wherein the detection of whether there are interfering CRS in one or more symbols of the second subframe comprises to:
measure a signal-to-noise ratio (SNR) associated with at least a first symbol of the one or more symbols; and
compare the measured SNR associated with the first symbol to a threshold.

29. The apparatus of claim 28, wherein the measured SNR comprises a combination of at least a first SNR for CRS on a first port and a second SNR for CRS on a second port.

30. A computer-readable medium storing computer-executable code for wireless communication by a user equipment (UE), comprising code to:
receive a downlink subframe from a serving base station, the downlink subframe at least partially overlapping with a second subframe transmitted by an intra-frequency neighboring cell (IFNC);
detect whether there are interfering cell-specific reference signals (CRS) in one or more symbols of the second subframe;
determine, based on whether interfering CRS are detected in the one or more symbols of the second subframe, a subframe type of the second subframe; and
cancel detected interfering CRS from the received downlink subframe based on the determined subframe type of the second subframe.
